(19) United States
(12) Patent Application Publication
(10) Pub. No.: US 2023/0269359 A1
(43) Pub. Date: Aug. 24, 2023

(54) MULTIVIEW DISPLAY FOR RENDERING MULTIVIEW CONTENT, AND DYNAMIC LIGHT FIELD SHAPING SYSTEM AND LAYER THEREFOR

(71) Applicant: EVOLUTION OPTIKS LIMITED, Christ Church (BB)

(72) Inventors: Raul MIHALI, Westport, CT (US); Thanh Quang TAT, Montreal, (CA); Mostafa DARVISHI, Brossard (CA); Joseph Ivar ETIGSON, Toronto (CA)

(21) Appl. No.: 18/006,451

(22) PCT Filed: Jul. 23, 2021
(86) PCT No.: PCT/US2021/070942

§ 371 Date: Jan. 23, 2023

Related U.S. Application Data
(60) Provisional application No. 63/056,188, filed on Jul. 24, 2020.

(51) Int. Cl. H04N 13/351; H04N 13/31; H04N 13/366; H04N 13/398; G02B 30/10; G02B 30/30

(52) U.S. Cl. CPC H04N 13/351; G02B 30/10; G02B 30/30; H04N 13/31; H04N 13/366; H04N 13/398

(57) ABSTRACT

Multiview displays are for rendering multiview content. A dynamic light field shaping system interfaces with light emanated from underlying pixels of a digital display to define a plurality of distinct view zones. The system includes a light field shaping layer (LFSL), which includes a series of light field shaping elements disposable relative to the digital display so to align the series of light field shaping elements with the underlying pixels in accordance with a current light field shaping geometry to thereby define a number of distinct view zones in accordance with the current geometry. The system may further include an actuator operable to translate the LFSL relative to the digital display to adjust alignment of the light field shaping elements with the underlying pixels in accordance with an adjusted geometry, thereby adjusting the plurality of distinct view zones.

### CROSS REFERENCE TO RELATED APPLICATIONS

This application claims priority to U.S. Provisional Application No. 63/056,188 filed Jul. 24, 2020, the entire disclosure of which is incorporated herein by reference.

### FIELD OF THE DISCLOSURE

The present disclosure relates to digital displays, and, in particular, to a multiview display for rendering multiview content, and dynamic light field shaping system and layer therefor.

### BACKGROUND

A multiview display (MVD) is a display that can present distinct images in different viewing directions simultaneously. For such displays, directionality may be provided through the use of optical layers, such as parallax barriers in conjunction with optically clear spacers. In such systems, a parallax barrier may allow light from certain pixels to be seen from designated viewing angles, while blocking light from propagating to other viewing angles. While such systems may allow for stereoscopic viewing or displaying direction-specific content, they often have a low tolerance on viewing angles, wherein even slight deviation in viewer position may expose a user to pixels illuminated for a different viewing zone. Such crosstalk may result in a poor viewing experience.

International Patent Application WO 2014/014603 A3 entitled “Crosstalk reduction with location-based adjustment” and issued to Dane and Bhaskaran on Sep. 4, 2014 discloses a location-based adjustment system for addressing crosstalk in MVD systems.

U.S. Pat. Application 9294759 B2 entitled “Display device, method and program capable of providing a high-quality stereoscopic (3D) image, independently of the eye-point location of the viewer” and issued to Hirai on Mar. 22, 2016 discloses a stereoscopic display system that tracks an eye location of a single user and adjusts a parallax barrier position to compensate therefor.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a multiview display for rendering multiview content, and dynamic light field shaping layer therefor that overcome some of the drawbacks of known techniques, or at least, provides a useful alternative thereto. Some aspects of this disclosure provide examples of such systems and methods.

In accordance with one aspect, there is provided a light field shaping system for interfacing with light emanated from underlying pixels of a digital display to define a plurality of distinct view zones, the system comprising a light field shaping layer (LFSL) comprising a series of light field shaping elements and disposable relative to the digital display so to align the series of light field shaping elements with the underlying pixels in accordance with a current light field shaping geometry to thereby define the plurality of distinct view zones in accordance with the current geometry, an actuator operable to translate the LFSL relative to the digital display to adjust alignment of the light field shaping elements with the underlying pixels in accordance with an adjusted geometry thereby adjusting the plurality of distinct view zones, and a digital data processor operable to activate the actuator to translate the LFSL to dynamically adjust the plurality of distinct view zones.

In some embodiments, the actuator is operable to translate the LFSL in a direction perpendicular and/or parallel to the digital display. In some embodiments, the actuator comprises a plurality of respective actuators operable to translate said LFSL in respective directions relative to the digital display.

In some embodiments, the LFSL comprises a parallax barrier (PB). The PB may, in some embodiments, comprise a micron- or sub-micron-resolution pattern disposed on a substrate. The PB may, in some embodiments, be formed via high-resolution photoplotting.

In some embodiments, the substrate comprises one or more of an optically clear substrate, a tempered glass, an anti-glare property, or an anti-glare coating.

In some embodiments, the PB comprises a first PB, wherein the system further comprises a second PB disposed relative to the digital display so to define an effective PB dimension for the LFSL, at least in part, as a function of a relative positioning of the first PB to the second PB, that at least partially dictates formation of the plurality of distinct view zones. In some embodiments, the actuator dynamically adjusts the relative positioning to dynamically adjust the effective PB dimension and thereby adjust formation of the plurality of distinct view zones.

In some embodiments, the LFSL comprises said first PB and said second PB.

In some embodiments, the system stores distinct LFSL geometries designated to correspondingly define a respective number of distinct view zones, and wherein the digital data processor is operable to activate the actuator, given a selected number of distinct view zones, to translate the LFSL to adjust the current geometry to a corresponding one of the distinct geometries to correspondingly select formation of the selected number of distinct view zones.

In some embodiments, the digital processor is further operable to receive as input view zone characterization data related to one or more of the plurality of distinct view zones, and automatically initiate a corresponding translation of the LFSL via the actuator to optimize formation of the one or more of the plurality of distinct view zones.

In some embodiments, the input data is representative of at least one of a view zone crosstalk, a view zone overlap, a view zone size, or a view zone boundary.

In some embodiments, the input data comprises a location of a viewer relative to a given view zone, and wherein the optimization optimizes formation of the given view zone for the viewer.

In some embodiments, the input data is acquired via an optical sensor operated within the one or more view zones to capture light emanated therein by the digital display via the LFSL, and communicated therefrom for processing by the digital processor.

In some embodiments, the optical sensor comprises a camera on a mobile communication device operated by a viewer via a corresponding mobile application in communication with said digital processor.

In some embodiments, the actuator is operable to translate the LFSL layer in an oscillatory pattern.

In some embodiments, the digital processor is further operable to receive as input a signal representative of an oscillatory motion.

In some embodiments, the oscillatory pattern is determined, at least in part, based on said signal representative of an oscillatory motion.

In some embodiments, the oscillatory pattern compensates for the oscillatory motion so to improve perception of content displayed within the plurality of distinct view zones.

In some embodiments, the system further comprises a sensing element operable to acquire data representative of said oscillatory motion and to output said signal.

In some embodiments, an at least partially nonuniform physical disposition of the series of light field shaping elements of the LFSL is at least partially matched with an at least partially nonuniform physical disposition of the underlying pixels

In some embodiments, the actuator is operable to translate the LFSL in response to a user adjustment signal received from a remote device.

In accordance with another aspect, there is provided a multiview display (MVD) system for dynamically adjusting a plurality of distinct view zones emanating therefrom, the system comprising a pixelated digital display and any of the light field shaping systems described herein.

In some embodiments, the MVD further comprises a non-transitory computer-readable medium comprising digital instructions to be implemented by one or more digital processors to produce an automatic perception adjustment of an input to be rendered via the digital display and the light field shaping system within one or more of the plurality of distinct view zones.

In some embodiments, the automatic perception adjustment is produced using a ray tracing process.

In some embodiments, the automatic perception adjustment corresponds to a reduced visual acuity of a user of the MVD system.

In accordance with another aspect, there is provided a method for dynamically adjusting a plurality of distinct view zones in a multiview display (MVD) system comprising a digital display defined by an array of pixels, and light field shaping layer (LFSL) disposed relative thereto, the method comprising: accessing current view zone characterization data related to one or more of the plurality of distinct view zones produced according to a current LFSL geometry relative to the array of pixels; digitally identifying a desirable adjustment in the view zone characterization based on the current view zone characterization data; and automatically translating the LFSL relative to the array of pixels, via the digital processor and an actuator operatively coupled to the LFSL, so to adjust the current LFSL geometry and thereby correspondingly adjust formation of the plurality of distinct view zones in accordance with the desirable adjustment.

In some embodiments, the desirable adjustment comprises an increased or decreased number of distinctly formed view zones.

In some embodiments, the current view zone characterization data comprises view zone image data indicative of a level of view zone crosstalk, and wherein the desirable adjustment comprises a reduction in view zone crosstalk within at least one of the distinct view zones.

In some embodiments, the current view zone characterization data comprises indication of given view zone boundary relative to a given viewer, and wherein the desirable adjustment comprises a distancing of the view zone boundary relative to the given viewer.

In some embodiments, the distancing is dynamically achieved upon laterally shifting the boundary, adjusting a lateral breadth of the given view zone, and/or increasing a depth of the given view zone to better accommodate a location of said given viewer.

In some embodiments, the translating comprises at least one of laterally translating the LFSL, or a component thereof, parallel to the digital display, translating the LFSL, or a component thereof, perpendicularly to the digital display, or translating a component of the LFSL to correspondingly adjust an effective light field shaping pitch of the LFSL.

In some embodiments, the current view zone characterization data is representative of at least one of a view zone crosstalk, a view zone overlap, a view zone size, or a view zone boundary.

In some embodiments, the current view zone characterization data is acquired via an optical sensor operated within the one or more view zones to capture light emanated therein by the digital display via the LFSL, and communicated therefrom for processing by said digital processor.

In some embodiments, the LFSL is translated so to correspondingly adjust a location or boundary of the plurality of distinct view zones in accordance with a desirable view zone location or boundary.

In some embodiments, the desirable view zone location or boundary is at least partially defined by viewer self-localization data.

In some embodiments, the method further comprises: emitting, via the MVD, respective MVD zone content in each of the plurality of distinct view zones; optically acquiring, from within one or more of the plurality of distinct view zones, the current view zone characterization data indicative of a perception of the respective MVD zone content as optically perceived therein; and iteratively translating the LFSL to automatically improve the perception.

In accordance with another aspect, there is provided a multiview display (MVD) system for displaying visual content in a plurality of distinct view zones, the system comprising: a pixelated digital display having an at least partially nonuniform distribution of pixels; and a light field shaping layer (LFSL) having an at least partially nonuniform distribution of light field shaping elements disposed thereon in accordance with said at least partially nonuniform distribution of pixels.

In some embodiments, the system further comprises an actuator operable to translate said LFSL relative to said pixelated digital display to further adjust alignment of said at least partially nonuniform distribution of light field shaping elements with said at least partially nonuniform distribution of pixels to thereby improve definition of the plurality of distinct view zones.

In some embodiments, the system further comprises a digital data processor operable to automatically activate said actuator to translate said LFSL in response to current view zone characterization data related to one or more of the plurality of distinct view zones.

In some embodiments, the system further comprises a digital data processor operable to activate said actuator to translate said LFSL in response to user input received from a remote device.

In some embodiments, the LFSL comprises a parallax barrier, and wherein said at least partially nonuniform distribution of light field shaping elements comprises a series of barriers configured to correspond with said at least partially nonuniform distribution of pixels.

In some embodiments, the LFSL comprises a digital parallax barrier operable to digitally render barriers corresponding with said at least partially nonuniform distribution of pixels.

In accordance with another aspect, there is provided a method for manufacturing a multiview display (MVD) system comprising a pixelated digital display, the method comprising: accessing an at least partially nonuniform pixel distribution of pixels of the pixelated digital display; patterning a series of light field shaping elements on a light field shaping layer (LFSL) in accordance with said at least partially nonuniform pixel distribution data; and disposing said LFSL relative to the pixelated digital display in alignment with said at least partially nonuniform pixel distribution so to define a plurality of distinct view zones corresponding to distinct visual content to be rendered by the pixelated digital display.

In one embodiment, the method further comprises imaging the pixelated digital display to acquire said at least partially nonuniform pixel distribution.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of an illustrative multiview display (MVD) operable to display distinct content in different view directions, in accordance with various embodiments;

FIGS. 2A, 2B and 2C are schematic diagrams illustrating a multiview self-identification system, a mobile device to be used therewith, and a schematic diagram of a self-identification system and mobile device interacting together, respectively, in accordance with various embodiments;

FIGS. 3A and 3B are schematic diagrams of an emitter array and an emitter, respectively, in accordance with various embodiments;

FIG. 4 is a process flow diagram of an illustrative multiview self-identification method, in accordance with various embodiments;

FIG. 5 is a process flow diagram of an alternative process step of FIG. 4, in accordance with various embodiments;

FIGS. 6A to 6C are schematic diagrams illustrating certain process steps of FIGS. 4 and 5, in accordance with various embodiments;

FIG. 7 is a schematic diagram illustrating an array of pixels in a multiview display system operable to display two images, in accordance with various embodiments;

FIG. 8 is a schematic diagram illustrating an array of pixels in a multiview display system wherein pixels corresponding to different views are separated by an unlit pixel, in accordance with various embodiments;

FIGS. 9A and 9B are schematic diagrams of an oscillating light field shaping layer element, such as a microlens or lenslet, overlaying a partially changing underlying set of pixels, in accordance with one embodiment;

FIGS. 10A to 10E are schematic diagrams illustrating exemplary oscillatory motions of a light field shaping layer element, in accordance with one embodiment;

FIGS. 11A and 11B are schematic diagrams illustrating more complex exemplary oscillatory motions of a light field shaping layer element, in accordance with one embodiment;

FIG. 12 is a process flow diagram of an illustrative ray-tracing rendering process, in accordance with one embodiment;

FIG. 13 is a diagram of exemplary input constant parameters, user parameters, and variables, for the ray-tracing rendering process of FIG. 12, in accordance with one embodiment;

FIGS. 14A and 14B are schematic diagrams illustrating an exemplary dynamic light field shaping layer operable to move perpendicularly relative to a pixelated display, in accordance with various embodiments;

FIGS. 15A and 15B are schematic diagrams illustrating an exemplary dynamic light field shaping system with independently addressable parallax barriers that may be displaced in two dimensions relative to a display screen, in accordance with various embodiments;

FIGS. 16A and 16B are schematic diagrams illustrating an exemplary dynamic light field shaping system adjustable to alter a number of distinct view zones, in accordance with various embodiments; and

FIG. 17A is a front perspective view of an exemplary multiview display system comprising a dynamic light field shaping layer, and FIGS. 17B and 17C are side perspective views of the front-right side and front-left side, respectively, of the exemplary multiview display system of FIG. 17A, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one ...” and “one or more...” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

The terms “view”, “view zone”, and “viewing zone”, used herein interchangeably, refer to a one-, two-, or three-dimensional region of space wherein an image or other content displayed by a light field display system, such as a multiview display (MVD), is viewable by one or more users. A view zone may also refer to an angular distribution of space projected radially from a light field display, or a portion thereof. In accordance with various embodiments, a view zone may correspond to one pupil of a user, or may correspond to a user as a whole. For instance, neighbouring view zones may correspond to areas in which content may be seen by different users. The skilled artisan will appreciate that a view zone, in accordance with various embodiments, may repeat, or have multiple instances, in 2D or 3D space based on the operational mode of, for instance, a MVD in use, and may refer to a region of space in which designated content may be viewed in a manner which provides the user with a positive viewing experience (e.g. a low degree of crosstalk between view zones, a sufficiently high resolution, etc.).

The systems and methods described herein provide, in accordance with different embodiments, different examples of a system and method for improving a user experience while viewing a light field display, such as a multiview display (MVD), using a dynamic light field shaping layer (also herein referred to for simplicity as “light field shaping layer”, or “LFSL”). While embodiments herein described may generally refer to a LFSL as one or more parallax barriers, the skilled artisan will appreciate that various applications may relate to a LFSL comprising a lenslet array, a microlens array, an array of apertures, and the like.

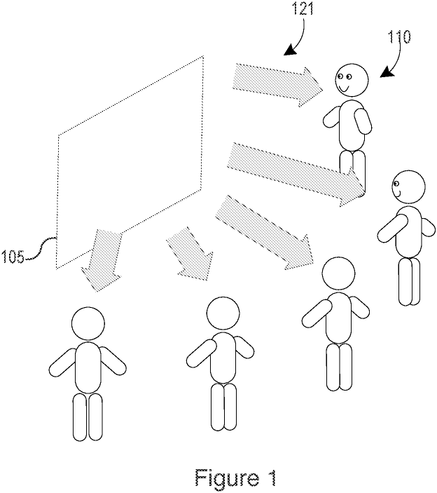

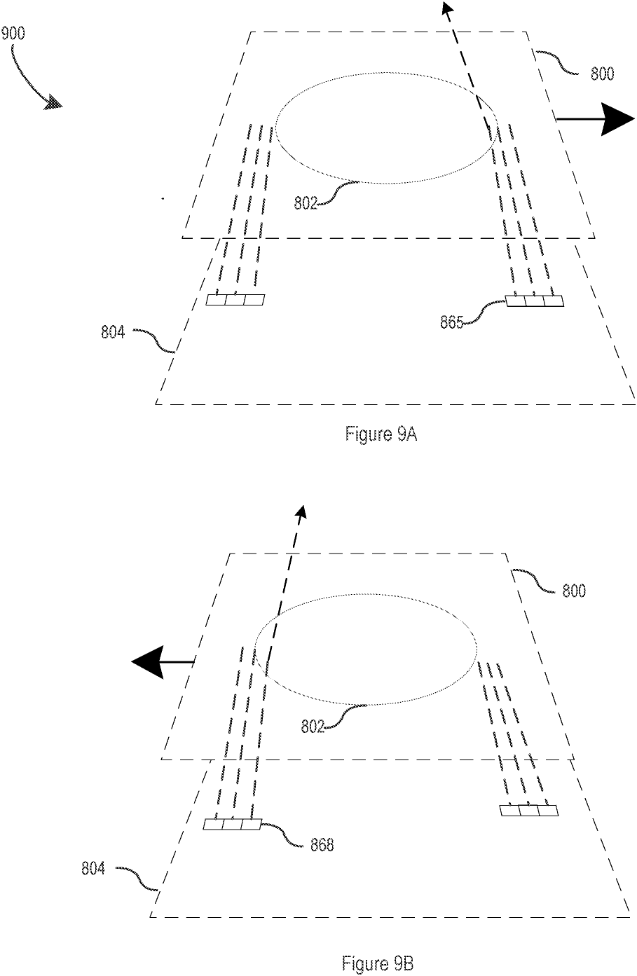

While various embodiments may apply to various configurations of light field display systems known in the art, exemplary light field display systems in which a dynamic light field shaping layer as described herein may apply will be described with reference to exemplary MVD systems (FIGS. 1 to 8) and exemplary microlens array systems (FIGS. 9A to 11B). Such examples are not intended to limit the scope of the systems and methods herein described, and are included to provide context, only, for non-limiting exemplary light field display systems.

Known MVD systems can be adapted to display viewer-related information in different MVD directions based on viewer identification and location information acquired while the user is interacting with the MVD. This can be achieved using facial or gesture recognition technologies using cameras or imaging devices disposed around the MVD. However, viewers can become increasingly concerned about their privacy, and generally uncomfortable with a particular technology, when subject to visual tracking, for instance not unlike some form of application-specific video surveillance. To address this concern, and in accordance with some embodiments, a viewer self-identification system and method can be deployed in which active viewer camera monitoring or tracking can be avoided. That being said, the person of ordinary skill in the art will readily appreciate that different user localization techniques may be employed in concert with the herein-described embodiments to benefit from reduced ghosting or cross-talk, wherein users can self-locate by capturing a direction or zone-specific signal, by entering a zone or direction-specific alphanumerical code or symbol, or by executing prescribed gestures or actions for machine vision interpretation, or again position themselves in accordance with prescribed and/or static view zones or directions. Likewise, the anti-ghosting techniques described herein may equally apply to user-agnostic embodiments in which direction or zone-specific content is displayed irrespective of user-related data, i.e. independent as to whether a particular, or even any user, is located within a prescribed or dynamically definable view zone.

For the sake of illustration, and in accordance with some embodiments, a multiview self-identification system and method are described to relay viewing direction, and optionally viewer-related data, in a MVD system so as to enable a given MVD to display location and/or viewer-related content to a particular viewer in or at a corresponding viewing direction or location, without otherwise necessarily optically tracking or monitoring the viewer. According to such embodiments, a viewer who does not opt into the system’s offering can remain completely anonymous and invisible to the system. Furthermore, even when opting into the system’s offerings at a particular location, the viewer can find greater comfort in knowing that the system does not, at least in some embodiments, capture or track visual data related to the viewer, which can otherwise make viewers feel like they are being actively watched or observed.

In one particular embodiment, this improvement is achieved by deploying a network-interfacing content-controller operable to select direction-specific content to be displayed by the MVD along each of distinct viewing directions in response to a viewer and/or location-participating signal being received from a viewer’s personal communication device. Such an otherwise effectively blind MVD does not require direct locational viewer tracking and thus, can be devoid of any digital vision equipment such as cameras, motion sensors, or like optical devices. Instead, position or directional view-related information can be relayed by one or more emitters disposed relative to the MVD and operable to emit respective encoded signals in each of said distinct viewing directions that can be captured by a viewer’s communication device and therefrom relayed to the controller to instigate display of designated content along that view. Where viewer-related data is also relayed by the viewer’s communication device along with a given encoded signal, the displayed content can be more specifically targeted to that viewer based on the relayed viewer-related data. In some embodiments, to improve the usability of the system, encoded signals may be emitted as time-variable signals, such as pulsatile and optionally invisible (e.g. InfraRed (IR) or Near InfraRed (NIR)) signals constrained to a particular view zone (e.g. having an angularly constrained emission beam profile bounded within each view zone), whereby such signals can be captured and processed by a viewer’s camera-enabled communication device. These and other such examples will be described in greater detail below.

With reference to FIG. 1, and in accordance with one embodiment, an exemplary MVD system will now be described. In this embodiment, an exemplary MVD 105 is illustrated comprising a digital display that can display two or more different images (or multimedia content) simultaneously with each image being visible only from a specific viewing direction. In this example, different viewers/users are viewing MVD 105 from different viewing directions, each viewer potentially seeing distinct content simultaneously. A passive or user-indiscriminate implementation could alternatively display different direction-specific content without viewer input, that is, irrespective of which viewer is located at any of the particular locations.

However, it may be desirable to present or display viewer-related content to a given viewer, say for example viewer 110 currently seeing MVD 105 from a specific viewing direction 121. To do so, MVD 105 may first know from which viewing direction viewer 110 is currently viewing MVD 105. As noted above, while technologies or methods may be used on MVD 105 to actively monitor body features (e.g. face recognition), body gestures and/or the presence of wearable devices (e.g. bracelets, etc.) of potential viewers, these technologies can be intrusive and bring privacy concerns. So, instead of having MVD 105 localizing/identifying viewer 110 itself, the methods and systems described herein, in accordance with different embodiments, therefore aim to provide viewer 110 with the ability to “self-identify” himself/herself as being in proximity to MVD 105 via a mobile device like a smartphone or like communication device, and send thereafter self-identified viewing direction/location data and in some cases additional viewer-related data to MVD 105, so that MVD 105 may display viewer-related content to viewer 110 via view direction 121.

In one non-limiting example, for illustrative purposes, MVD 105 may be implemented to display arrival/departing information in an airport or like terminal. The systems and methods provided herein, in accordance with different embodiments, may be employed with a system in which a viewing direction 121 can be used to display the same flight information as in all other views, but in a designated language (e.g. English, Spanish, French, etc.) automatically selected according to a pre-defined viewer preference. In some embodiments, a self-identification system could enable MVD 105 to automatically respond to a viewer’s self-identification for a corresponding viewing direction by displaying the information for that view using the viewer’s preferred language. In a similar embodiment, the MVD could be configured to display this particular viewers flight details, for example, where viewer-related data communicated to the system extends beyond mere system preferences such as a preferred language, to include more granular viewer-specific information such as upcoming flight details, gates, seat selections, destination weather, special announcements or details, boarding zone schedule, etc. In yet other embodiments, the MVD may comprise a multiview television (MVTV) screen operable to display distinct content to a plurality of view zones, and may further have “smart” television capabilities, such as the ability to store and execute digital applications, and the like.

Generally, MVD 105 discussed herein will comprise a set of image rendering pixels and a light field shaping layer or array of light field shaping elements disposed between a digital display and one or more users so to controllably shape or influence a light field emanating therefrom. In some embodiments, the MVD 105 may comprise a lenticular MVD, for example comprising a series of vertically aligned or slanted cylindrical lenses (e.g. part of a lenticular sheet or similar), or parallax barriers of vertically aligned apertures, located or overlaid above a pixelated display, although the systems and methods described herein may work equally well for any type of MVD or any 1D or 2D display segregating distinct views by location or orientation, including x and/or y. For example, a 1D or 2D MVD may layer a 2D microlens array or parallax barrier to achieve projection of distinct views along different angles spread laterally and/or vertically.

In accordance with some embodiments, a MVD may include a dynamically variable MVD in that an array of light shaping elements, such as a microlens array or parallax barrier, can be dynamically actuated to change optical and/or spatial properties thereof. For example, a liquid crystal array can be disposed or integrated within a MVD system to create a dynamically actuated parallax barrier, for example, in which alternating opaque and transparent regions (lines, “apertures”, etc.) can be dynamically scaled based on different input parameters. In one illustrative example, a 1D parallax barrier can be dynamically created with variable line spacing and width such that a number of angularly defined views, and viewing region associated therewith, can be dynamically varied depending on an application at hand, content of interest, and/or particular physical installation. In a same or alternative embodiment in which view zone-defining light field shaping elements are disposed to form a layer at a distance from an underlying pixelated digital display, for example, this distance can also, or alternatively, be dynamically controlled (e.g. servo-actuated, micro-stepper-activated) to further or otherwise impact MVD view zone determination and implementation. As such, not only can user-related content be selectively displayed according to different view directions, so can the different view directions be altered for instance, to increase a view zone angle spread, repetition frequency, etc. In such embodiments, user self-localisation techniques as described herein may be adjusted accordingly such that user self-localisation signals are correspondingly adjusted to mirror actuated variations in MVD view zone characterization and implementation.

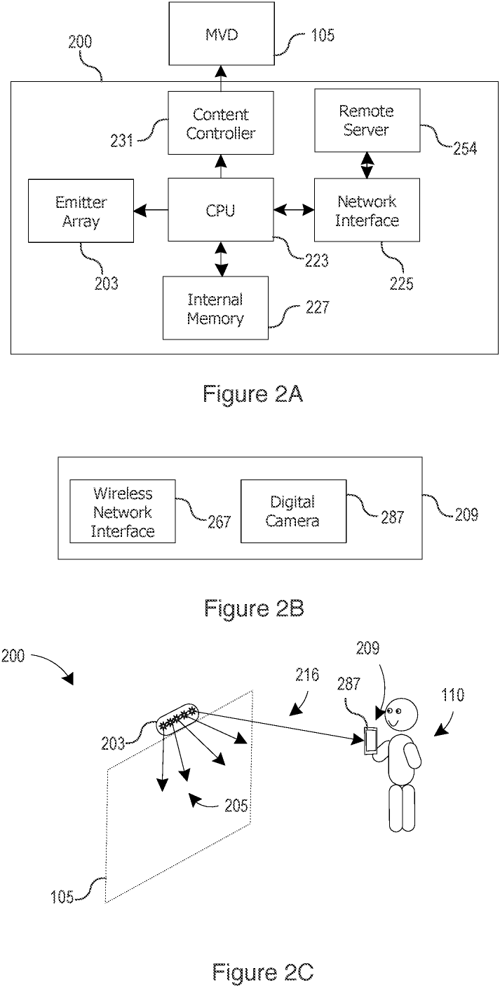

With reference to FIGS. 2A to 2C, and in accordance with different exemplary embodiments, a multiview self-identification system for providing viewing direction data to a MVD so as to enable this MVD to provide viewer-related content to a viewer in a corresponding viewing direction, generally referred to using the numeral 200, will now be described. Self-identification system 200 is generally communicatively linked to MVD 105. In some embodiments, system 200 may be embedded in MVD 105, or it may be provided as a separate device and be attached/connected to an existing MVD 105. System 200 generally further comprises an emitter array 203 comprising one or more emitters, each operable to emit highly directional (time-dependent or variable) encoded emissions. In some embodiments, system 200 may be embedded in MVD 105 as a single enclosure, while emitter array 203 may be external and in communication with one or more components of MVD 105 and/or system 200. Further, various additional sensors (e.g. temperature, humidity, and the like) may also be integrated within the MVD 105 or system 200.

In some embodiments, emitter array 203 comprises one or more emitters, each emitter configured to emit a time-dependent encoded emission (e.g. blinking light, such as a red light, or other pulsatile waveform, such as an encoded IR signal), the emission being substantially in-line, directionally-aligned or parallel to, a corresponding viewing direction of the MVD, so as to be only perceived (or preferentially perceived) by a viewer, camera or sensor when a viewer is viewing the MVD from this corresponding view direction. This is schematically illustrated in FIG. 2C, which shows emitter array 203 being located, as an example, above or on top of MVD 105, and emitting therefrom a multiplicity of highly directional encoded emissions 205. Viewer 110 is shown using a camera 287 of his/her mobile device 209 to intercept encoded emission 216, which is only one visible from his/her location, and which corresponds to that particular viewing direction (e.g. viewing direction 121 of FIG. 1). Naturally, in embodiments where view zone boundaries or characteristics are dynamically actuated via a dynamically actuated MVD, zone-specific user self-localization signals may be equally adjusted to mirror any corresponding spatial changes to the view zone definitions, such as via mechanical (mechanically actuated / reoriented emitters), optical (actuated emission beam steering / forming optics) or like mechanisms.

Generally, emitter array 203 may be located or installed within, on or close to MVD 105, so as to be in view of a viewer (or a mobile device 209 held thereby) viewing MVD 105. In some embodiments, due to the directionality of the emitted emissions, a viewer within a given view direction of MVD 105 may only be able to perceive one corresponding encoded emission 216 from one corresponding emitter.

Generally, mobile device 209 as considered herein may be any portable electronic device comprising a camera or light sensor and operable to send/receive data wirelessly. This is schematically illustrated in FIG. 2B, wherein mobile device 209 comprises a wireless network interface 267 and a digital camera 287. Mobile device 209 may include, without limitation, smartphones, tablets, e-readers, wearable devices (watches, glasses, etc.) or similar. Wireless network interface 267 may be operable to communicate wirelessly via Wi-Fi, Bluetooth, NFC, Cellular, 2G, 3G, 4G, 5G and similar. In some embodiments, digital camera 287 may be sensitive to IR light or NIR light, such that an encoded IR or NIR signal 216 can be captured thereby without adversely impacting the viewer’s experience and/or distracting other individuals in the MVD’s vicinity. In accordance with other embodiments, other non-visible signals, such as radio frequency (RF) or sound, may also be considered. Such embodiments may relate to non-visible signals which have, for instance, been deemed safe for human tracking and identification (e.g. FDA approved). Naturally, such signals may also be employed in embodiments wherein a user is additionally or alternatively tracked during use of a MVD system.

Accordingly, in some embodiments, emitter array 203 may comprise infrared (IR) emitters configured to emit IR light, wherein the encoded emission is a time-dependent pulsatile waveform or similar (e.g. blinking IR light having a direction-encoded pulsatile waveform, frequency, pattern, etc.). In some embodiments, the 38 kHz modulation standard or a 38 kHz time-dependent discrete modulation signal may be used, however, other time-dependent signal modulation techniques (analog or digital) known in the art may be used to encode the signal. Thus, using an IR sensitive digital camera 287, an encoded IR emission may be recorded/intercepted while being invisible to viewer 110, so to not cause unnecessary discomfort.

In some embodiments, the frequency of the encoded emission or a change thereof may, at least in part, be used to differentiate between different emitters of emitter array 203 (e.g. in case of unintended cross-talk between emitters). For example, a specific pulsatile frequency, or the distance a signal travels in respect of its nominal wavelength, may be used for different view directions.

Thus, in some embodiments, system 200 may further comprise a dedicated application or software (not shown) to be executed on mobile device 209, and which may have access to one or more hardware digital cameras therein. This dedicated application may be operable to acquire live video using a camera of mobile device 209, identify within this video an encoded emission if present and automatically extract therefrom viewing direction or location data.

Furthermore, emitter array 203 may have the advantage that it only requires viewer 110 to point a camera in the general direction of MVD 105 and emitter array 203, whereby the encoded time-variable signal is projected in an angularly constrained beam that sweeps a significant volume fraction of its corresponding view zone (i.e. without spilling over into adjacent zones), avoiding potentially problematic camera/image alignment requirements that could otherwise be required if communicating directional information via a visible graphic or code (e.g. QR code). Given such considerations, even if during acquisition the location of the camera/sensor changes (e.g. due to hand motion, etc.), the dedicated application may be operable to follow the source of encoded emission 216 over time irrespective of specific alignment or stability.

In some embodiments, system 200 may further comprise a remote server 254, which may be, for example, part of a cloud service, and communicate remotely with network interface 225. In some embodiments, content controller 231 may also be operated from remote server 254, such that, for example, viewer-specific content can be streamed directly from remote server 254 to MVD 105.

In some embodiments, multiple MVDs may be networked together and operated from, at least partially, remove server 254.

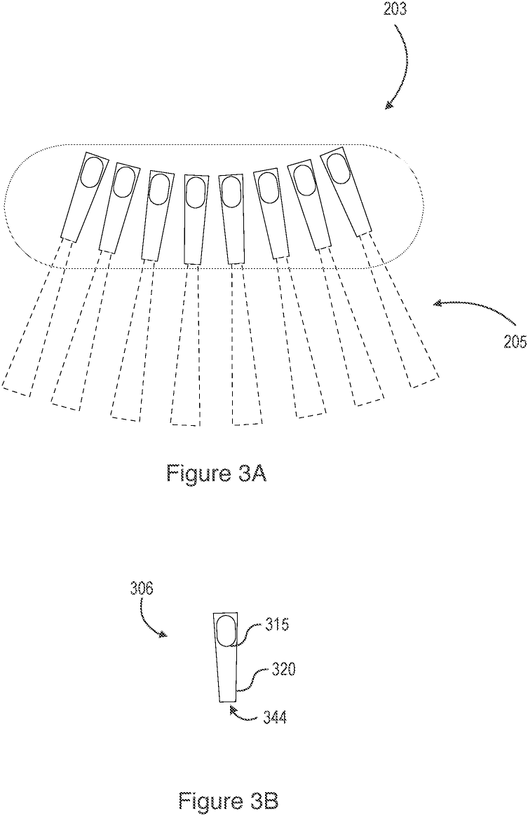

FIGS. 3A and 3B show a schematic diagram of an exemplary emitter array 203 and one exemplary emitter 306 therefrom, respectively. FIG. 3A shows emitter array 203 comprising (as an example only) 8 IR emitters configured to emit directionally encoded emissions 205. In some embodiments, as explained above, each IR emitter in emitter array 203 is configured/aligned/oriented so that the IR light/emission emitted therefrom is aligned with a viewing direction of MVD 105. In some embodiments, the relative orientation of each emitter may be changed manually at any time, for example in the case where emitter array 203 is to be installed on a different MVD. Further, the emitter architecture of FIG. 3A may or may not be monolithic, and the frequency of each emitter may be adjusted individually, regardless of its integration with neighbouring emitters. FIG. 3B shows an exemplary emitter 306, which may comprise an IR LED 315 operable to emit IR light at a given pulsatile modulation, a sleeve/recess/casing 320 for blocking IR light from being emitted outside the intended orientation/direction, and an opening 344 for the light to exit.

Other configurations of emitter array 203 or emitter 306 may be considered, without departing from the general scope and nature of the present disclosure. For example, directional light sources, such as lasers and/or optically collimated and/or angularly constrained beam forming devices may serve provide directional emissions without physical blockers or shutters, as can other examples readily apply.

With continued reference to FIGS. 2A to 2C, self-identification system 200 may further comprise a processing unit 223, a network interface 225 to receive view direction identification data from personal mobile device 209 and/or any other viewer-related data (directly or indirectly), a data storage unit or internal memory 227 to store viewing direction data and viewer-related data, and a content controller operable to interface and control MVD 105. Internal memory 227 can be any form of electronic storage, including a disk drive, optical drive, read-only memory, random-access memory, or flash memory, to name a few examples. Internal memory 227 also generally comprises any data and/or programs needed to properly operate content controller 231, emitter array 203, and content controller 231.

In some embodiments, network interface 225 may send/receive data through the use of a wired or wireless network connection. The skilled artisan will understand that a different means of wirelessly connecting electronic devices may be considered herein, such as, but not limited to, Wi-Fi, Bluetooth, NFC, Cellular, 2G, 3G, 4G, 5G or similar.

In some embodiments, the user may be required to provide input via mobile device 209 before the viewing direction data is sent to MVD 105.

As mentioned above, in some embodiments, at any time viewer 110 finds themself in proximity to MVD 105, they can opt to open/execute a dedicated application on their portable digital device 209 to interface with the system. In other embodiments, this dedicated application may be embedded into the operating system of mobile device 209, eliminating the need to manually open the application. Instead, viewer 110 may touch a button or similar, such as a physical button or one on a graphical user interface (GUI) to start the process. Either way, mobile device can 209 access digital camera 287 and start recording/acquiring images and/or video therefrom, and thus capture an encoded signal emitted in that particular view direction.

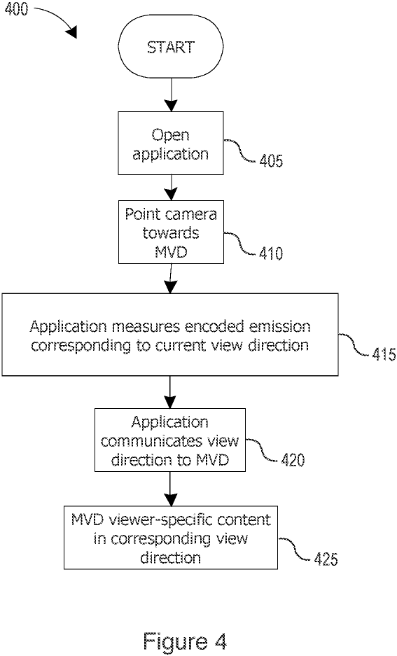

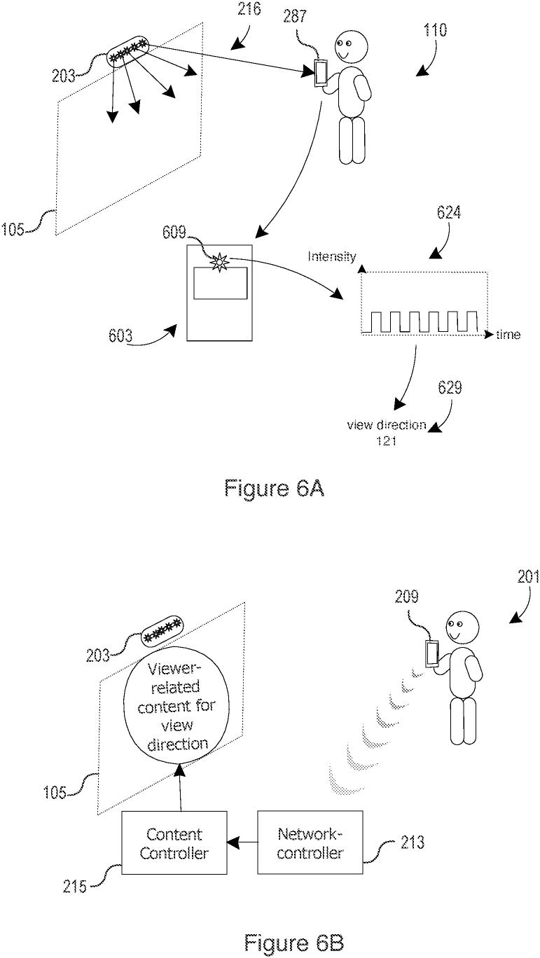

For example, and with added reference to the process 400 illustrated in FIG. 4, once a corresponding application has been launched or activated at step 405, at step 410, viewer 110 can point camera 287 towards MVD 105 and emitter array 203. In some embodiments, there may be no need to interact with the image acquisition process (e.g. zoom, tilt, move, etc.). Indeed, as long as the time-dependent encoded emission perceived from emitter array 203 corresponding to the physical location and viewing direction of viewer 105 is within the frame, mobile device 209 (via dedicated application/software) may be operable to extract therefrom the encoded data at step 415. This is schematically illustrated in FIG. 6A, wherein mobile camera 287 is used by viewer 110 (via the dedicated application) to record a video segment and/or series of images 603 comprising encoded emission 216. The dedicated application applies any known image recognition method to locate the emission of emitter 609 within image 603 and extract therefrom the corresponding pulsatile encoded transmission 624, thereby extracting the corresponding viewing direction data 629.

In some embodiments, a notification and/or message may be presented to the viewer on the mobile device to confirm that the encoded emission was correctly located and decoded, to display the decoded location, and/or to authorize further processing of the received location information and downstream MVD process. It will be appreciated that while the viewing location may be immediately decoded and confirmed, the encoded information may rather remain as such until further processed downstream by the system.

Once the view-related data 629 has been captured, the mobile device can communicate at step 420 this information to MVD 105 (using wireless network interface 267), optionally along with viewer-related data. This viewer-related data can be used, for example, to derive viewer-related content to be presented or displayed on MVD 105. In some embodiments, viewer-related data may comprise a language preference or similar, while in other embodiments it may comprise viewer-specific information, including personal information (e.g. personalized flight information, etc.). In some embodiments, as illustrated in FIG. 6B, mobile device 209 communicates directly with network controller 213 of self-identification system 200, which may in this example be uniquely connected to MVD 105 (either integrated into MVD 105 or included within the same hardware unit as emitter array 203, for example). Once network-controller 213 receives this viewing direction data and viewer-specific data, it relays it to content-controller 215, which uses it to display viewer-related content on MVD 105 via the corresponding viewing direction 121.

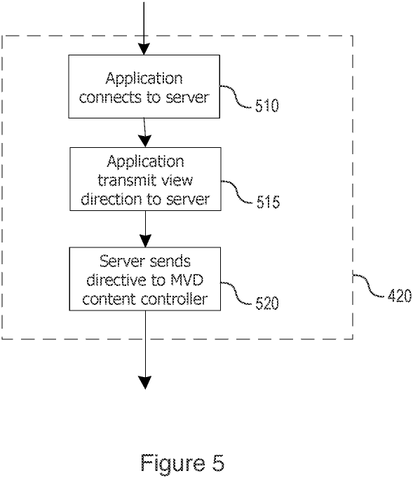

Alternatively, as shown in FIG. 5 and illustrated schematically in FIG. 6C, and according to another embodiment, step 415 may be modified to include communicating to remote server 254 instead. At step 510 of FIG. 5, instead of connecting directly with network-interface 225 of system 200, mobile device 209 may communicate with remote server 254, by way of a wireless internet connection. At step 515, mobile device 209 may then communicate viewing direction data and viewer-related data. In addition, in this example, additional data identifying for example MVD 105 in a network of connected MVDs may also be provided in the encoded emission. In this exemplary embodiment, remote server 254 may be part of a cloud service or similar, which links multiple MVDs over a network and wherein the dedicated application for mobile device 209 may be configured to communicate user-related data (e.g. user profile, user identification, user preferences, etc.). At step 520, remote server 254 may then connect and communicate with network-interface 225 of system 200. In some embodiments, selected view-related data may be directly selected by the mobile application and relayed to the system for consideration. In other embodiments, a user identifier may otherwise be relayed to the remote server 254, which may have operative access to a database of stored user profiles, and related information, so to extract therefrom user-related data usable in selecting specific or appropriate user and view-direction/location content.

In some embodiments, additional information such as the physical location of MVD 105 may be encoded in the encoded emission itself or derived indirectly from the location of the mobile device 209 (via a GPS or similar).

In some embodiments, viewer-specific content may comprise any multimedia content, including but without limitation, text, images, photographs, videos, etc. In some cases, viewer-related content may be a same content but presented in a different way, or in a different language.

In some embodiments, the viewer may have the option of interacting dynamically with the dedicated mobile application to control which viewer-related content is to be displayed in the corresponding view direction of the MVD 105. In other cases, the viewer may pre-configure, before interacting with the MVD, the dedicated application to select one or more viewer-specific content, and/or pre-configure the application to communicate to MVD 105 to display viewer-specific content based on a set of predefined parameters (e.g. preferred language, etc.).

In practice, the viewing of conventional MVD systems, examples of which may include, but are not limited to, those abovementioned, may traditionally be accompanied by various visual artifacts that may detract from or diminish the quality of a user viewing experience. For instance, a MVD system employing a light field shaping element (e.g. a parallax barrier, a lenslet array, a lenticular array, waveguides, and the like) may be designed or otherwise operable to display light from different pixels to respective eyes of a viewer in a narrow angular range (or small region of space). In some cases, even a slight movement of a viewer may result in one eye perceiving light intended for the other eye. Similarly, when viewing a MVD operative to display different images to different viewers, user movement may result in the presentation of two different images or portions thereof to a single viewer if pixels intended to be blocked or otherwise unseen by that user become visible. Such visual artifacts, referred to herein interchangeably as “ghosting” or “crosstalk”, may result in a poor viewing experience.

While various approaches have been proposed to mitigate crosstalk in stereoscopic systems, such as that disclosed by International Patent Application WO 2014/014603 A3 entitled “Crosstalk reduction with location-based adjustment” and issued to Dane and Bhaskaran on Sep. 4, 2014, a need exists for a system and method of rendering images in a manner that improves user experience for MVD systems that, for instance, do not provide an adverse impact on a neighbouring view (e.g. compensate for a neighbour view by adjusting a pixel value, detracting from the quality of one or more displayed images). Furthermore, a need exists for a system and method to this end that is less computationally intensive than the dynamic adjustments required to apply corrective contrast measures, such as those that might reverse a ghosting effect, for individually identified pixels for certain images. As such, herein disclosed are various systems and methods that, in accordance with various embodiments, relate to rendering images in MVDs that improve user experience via mitigation of ghosting and/or crosstalk effects.

In accordance with various embodiments, a parallax barrier as described herein may be applied to a MVD wherein each view thereof displayed relates to a different user, or to different perspectives for a single viewer. However, inclusions of additional means known in the art for providing a plurality of content (e.g. images, videos, text, etc.) in multiple directions, such as lenslet arrays, lenticular arrays, waveguides, combinations thereof, and the like, fall within the scope of the disclosure.

Furthermore, various aspects relate to the creation of distinct view zones that may be wide enough to encompass both eyes of an individual viewer, or one eye of a single user within a single view zone, according to the context in which a MVD may be used, while mitigating crosstalk between different views.

Description will now be provided for various embodiments that relate to MVD systems that comprise a parallax barrier, although the skilled artisan will appreciate that other light field shaping elements may also be employed in the systems and methods herein described.

Conventional parallax barriers may comprise a series of barriers that block a fraction (N-1)/N of available display pixels while displaying N distinct views in order to display distinct images. For example, a MVD displaying two views (i.e. N = 2) may have half of its pixels used for a first view zone, while the other half (blocked from the first view zone) are used for a second view zone. In such a system, narrow view zones are created such that even minute displacement from an ideal location may result in crosstalk, reducing image quality due to crosstalk between adjacent views.

In accordance with various embodiments, crosstalk may be at least partially addressed by effectively creating “blank” views between those intended for viewing that comprise pixels for image formation. That is, some pixels that would otherwise be used for image formation may act as a buffer between views. For instance, and in accordance with various embodiments, such buffers may be formed by maintaining such pixels inactive, unlit, and/or blank. Such embodiments may allow for a greater extent of viewer motion before crosstalk between view zones may occur, and thus may improve user experience. For instance, in the abovementioned example of a MVD with N views, a barrier may block a fraction of (2N-1)/2N pixels in an embodiment in which view zones are separated by equal-width blank “viewing zones”. That is, for a MVD displaying two views (N = 2), four “views” may be created, wherein each view containing different images is separated by a “view” that does not contain an image, resulting in 75% of pixels being blocked by a barrier while 25% are used to create each of the two images to be viewed.

The abovementioned embodiment may reduce effects of crosstalk, as a viewer (i.e. a pupil, or both eyes of a user) may need to completely span the width of a view zone to perceive pixels emitting light corresponding to different images. However, the images formed by such systems or methods may have reduced brightness and/or resolution due to the number of pixels that are sacrificed to create blank views. One approach to mitigating this effect, and in accordance with various embodiments, is to address pixels in clusters, wherein clusters of pixels are separate from one another by one or more blank pixels. For instance, and in accordance with at least one of the various embodiments, a cluster may comprise a “group” or subset of four cohesively distributed (i.e. juxtaposed) pixels and utilised to produce a portion of an image, and clusters may be separated by a width of a designated number of pixels that may be left blank, unlit, or inactive, or again activated in accordance with a designated buffer pixel value (i.e. buffer pixel(s)). While the following description refers to a one-dimensional array of pixels grouped into clusters of four pixels each, the skilled artisan will appreciate that the concepts herein taught may also apply to two-dimensional arrays of pixels and/or clusters, wherein clusters may comprise any size in one or two dimensions

While this particular example (four active pixels to one blank pixel) may provide an appropriate ratio of used or lit pixels to blank or unlit pixels for a high quality viewing experience in some systems, the skilled artisan will appreciate that various embodiments may comprise different ratios of active to blank pixels, or variable ratios thereof, while remaining within the scope of the disclosure. For instance, various embodiments may comprise varying the ratio of active to blank pixels throughout a dimension of a display, or, may comprise varying the ratio of active to blank pixels based on the complexity of an image or image portion. Such variable ratio embodiments may be particularly advantageous in, for instance, a lenticular array-based MVD, or other such MVD systems that do not rely on a static element (e.g. a parallax barrier) to provide directional light.

As such, various embodiments as described herein may comprise the designated usage and/or activation of pixels in a display in addition to a physical barrier or light field shaping elements (e.g. lenses) that allow light from specific regions of a display to be seen at designated viewing angles (i.e. directional light). Dynamic or designated pixel activation sequences or processes may be carried out by a digital data processor directly or remotely associated with the MVD, such as a graphics controller, image processor, or the like.

To further describe a physical parallax barrier that may be used in accordance with various embodiments, the notation PB (N, p, b) will be used henceforth, where PB is a physical parallax barrier used with a display creating N views, where p is the number of pixels in a cluster, as described above, designated as active to contribute to a particular image or view, wherein clusters may be separated by a number of pixels b that may be blank, inactive, or unlit. In accordance with various embodiments, b may be 0 where blank pixels are not introduced between view-defining clusters, or otherwise at least 1 where one or more blank pixels are introduced between view-defining clusters.

Embodiments may also be described by an effective pixel size sₚₓ* representing the size of a pixel projection on the plane corresponding to a physical parallax barrier. The slit width SW of the physical barrier may thus be defined as SW = p sₚₓ*, and the physical barrier width between slits BW as BW = [(N-1) p + N b] sₚₓ*. It may also be noted that, for a system in which D is the distance between the parallax barrier and a viewer and g is the gap between the screen and the physical barrier plane (i.e. D + g relates to the distance between the viewer and the screen), the effective pixel size sₚₓ* may be computed as sₚₓ* = sₚₓ [D / (D + g)], where sₚₓ is the screen’s actual pixel size (or pixel pitch).

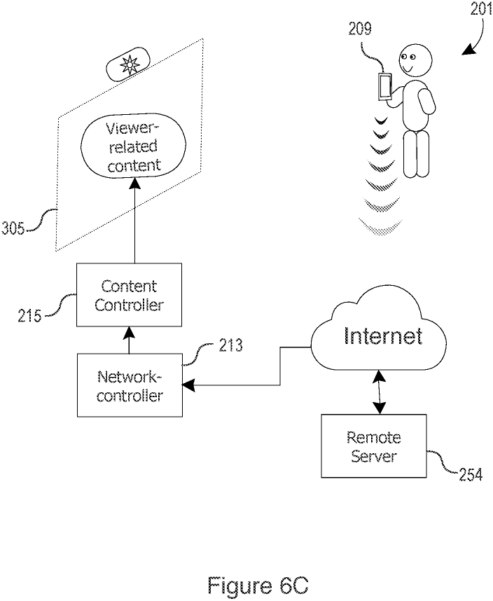

A geometry of a conventional parallax barrier MVD system is further described in FIG. 7, which illustrates, using the abovementioned notation, a parallax barrier of PB (2, 4, 0). In this example, 2 views (N = 2, where pixels corresponding to different images are referred to as white or dark, for illustrative purposes only) are created using clusters of 4 pixels each, wherein each cluster is separated by 0 blank pixels. Here, white clusters 722 of white pixels 724 corresponding to a first image to be displayed by screen 720 are only visible through a parallax barrier 730 to a first viewer 710 through slits of slit width 734 (SW) in the barrier 730. Dark clusters 727 of dark pixels 725 are, from the perspective of the first viewer 710, blocked by barriers 735 of barrier width 737 (BW), while those same dark pixel clusters 727 are visible to a second viewer 715. In this case, the barrier 730 is at a gap distance 740 (g) away from the screen 720, while the first viewer 710 is at a distance 742 (D) away from the barrier 730. As described above, such a system may be sensitive to crosstalk/ghosting effects. Indeed, even a slight movement from the first viewer 710 would result in perception of one or more dark pixels 725, while movement from the second viewer 715 would result in perceived images being contaminated with white pixels 724.

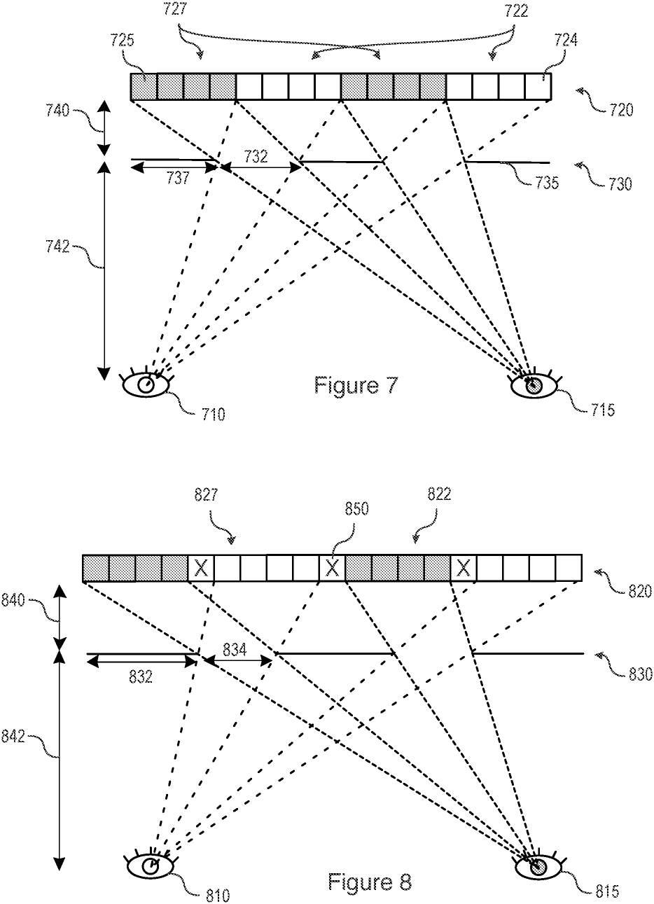

FIG. 8, on the other hand, incorporates blank pixels 850 within a display 820, in accordance with various embodiments. In this example, denoted PB (2, 4, 1), white clusters 827 of four white pixels are visible to a first viewer 810 through slits of width 834, while dark clusters 822 of 4 dark pixels each are blocked to the first viewer 810 by barriers of width 832. conversely, a second viewer 815 may see clusters of dark pixels 822, while the barriers block the second viewer from perceiving white clusters 827. In this case, the parallax barrier 830 is a gap distance 840 from the screen 820, while the first viewer is a distance 842 from the parallax barrier. Unlike the example of FIG. 7, in FIG. 8, if either viewer shifts position in any direction, they will not immediately be presented with pixels corresponding to a different image. Rather, upon movement, their field of view will first incorporate a blank pixel 850 (marked with an ‘X’ in FIG. 8), which is inactive, and thus not producing light that will result in crosstalk. Thus, the presence of blank pixels at designated locations reduces crosstalk effects in a MVD system, in accordance with various embodiments.

In the example of FIG. 8, wherein N = 2, p = 4, and b = 1, 80 % of the number of pixels that would have otherwise been used to form a particular image in FIG. 7 may be active. As such, only 20 % of the resolution is lost compared to that of FIG. 7, which comprised an “optimal” barrier in that all pixels were used to form an image. However, the perception of crosstalk may be significantly reduced, even in embodiments wherein only a single pixel is used to separate clusters of image-producing pixels.

In accordance with various embodiments, the presence of blank, unlit, or inactive pixels may effectively increase a viewing zone size. That is, a viewer may comfortably experience a larger area wherein their view or perception does not experience significant crosstalk.

In accordance with various embodiments, blank pixels may be placed at the interface between adjacent clusters of pixels corresponding to different images and/or content. Such configurations may, in accordance with various embodiments, provide a high degree of resolution and/or brightness in images while minimizing crosstalk.

The following Table provides non-limiting examples of display pixel parameters that may relate to various embodiments, with the associated percentage of a total number of available pixels on a display that correspond to a particular image or view, and thus relate to resolution and brightness of a respective image. The skilled artisan will appreciate that such parameters are exemplary, only, and do no limit the scope of the disclosure. Furthermore, the skilled artisan will appreciate that while such parameters may, in accordance with some embodiments, refer to a number of pixels in one dimension, they may also apply to methods and systems operable in two dimensions. For instance, a pixel cluster may be a p by r array of pixels cohesively distributed in two dimensions on a display. In some embodiments, buffer regions of unlit pixels may be variable in different dimensions (e.g. a buffer width of b pixels between clusters in a horizonal direction and c pixels between clusters in a vertical direction).

| N | p | b | % per view (%) |
|---|---|---|---|
| 2 | 4 | 1 | 40 |
| 2 | 2 | 1 | 33 |
| 2 | 2 | 0 | 50 |
| 2 | 1 | 1 | 25 |
| 3 | 1 | 0 | 33 |
| 3 | 3 | 1 | 25 |
| 3 | 2 | 0 | 33 |
| 4 | 1 | 0 | 25 |

While various examples described relate to MVD displays comprising parallax barriers, the skilled artisan will appreciate that the systems and method herein disclosed may further relate to other forms of MVD displays. For instance, and without limitation, blank or inactive pixels may be employed with MVD displays comprising lenticular arrays, wherein directional light is provided through focusing elements. For instance, the principle of effectively “expanding” a view zone via blank pixels that do not contribute to crosstalk between views in such embodiments remains similar to that herein described for the embodiments discussed above.

Further embodiments may relate to the employ of unlit pixels in dynamic image rendering (e.g. scrolling text, videos, etc.) to reduce crosstalk or ghosting. Similarly, yet other embodiments relate to the use of blank pixels to reduce crosstalk related to systems that employ dynamic pupil or user tracking, wherein images are rendered, for instance, on demand to correspond to a determined user location, or predicted location (e.g. predictive location tracking). Similarly, embodiments may relate to a view zone that encompasses one or more eyes of a single user, the provision of stereoscopic images wherein each eye of a user is in a respective view zone, or providing a view zone corresponding to the entirety of a user, for instance to provide a neighbouring view zone for an additional user(s).

While the abovementioned examples of MVD systems employing viewer localisation and/or cross-talk mitigation are provided as exemplary platforms that may utilise a dynamic light field shaping layer (LFSL) as herein described, the skilled artisan will appreciate that various embodiments may relate to other MVD systems. For instance, a conventional MVD screen that does not require a user to self-locate may employ a LFSL to, for instance, reduce crosstalk between view zones without introducing buffer pixels, to alter one or more view zone positions, or to change a number of distinct MVD view zones.

For example, the systems and methods described herein provide, in accordance with different embodiments, different examples of a light field display system and method in which a LFSL disposed upon a digital pixel display is operable to move in one or more dimensions so to provide dynamic control over a view zone location, or to improve a user experience. For example, and in accordance with some embodiments, a LFSL may vibrate (e.g. move or oscillate to and from relative thereto) so to reduce perceived optical artifacts, provide an increased perceived resolution, or like benefits, thus improving a user experience.

For example, light field displays typically have a reduced perceived resolution compared to the original resolution of the underlying pixel array. This is because light emitted from a subset of pixels of the digital display may be, at least partially, blocked or attenuated by a given placement of different optical elements of the light field shaping layer. Accordingly, at least some of the underlying digital display pixels become unavailable or ineffective in rendering the intended image. Furthermore, while digital display pixels typically emit an isotropically distributed light field such that light emitted by each pixel can typically reach the viewers pupils, light field rendering solutions will invariably produce more directional light fields that, in some circumstance, may not intersect with a user’s pupil location(s). Accordingly, visual artefacts and/or a reduced perceived resolution may ensue.

In accordance with some of the herein-described embodiments, means are provided to vibrate the LFSL relative to the digital display at a rate generally too fast to be perceived by a user viewing the display but with the added effect that each optical element of the LFSL may, over any given cycle, allow light emitted from a larger number of pixels to positively intersect with the viewer’s pupils than would otherwise be possible with a static LFSL configuration.

In some embodiments, the implementation of a dynamic or vibrating light field shaping layer can result in an improved perceived resolution of the adjusted image, thereby improving performance of an image perception solution being executed. As an exemplary application of an image perception solution enabled by a dynamic light field shaping layer, the following description relates to a manipulation of a light field using a light field display for the purpose of accommodating a viewer’s reduced visual acuity. The herein described solutions may also be applied in, for instance, providing 3D images, multiple views, and the like.

Some of the embodiments described herein provide for digital display devices, or devices encompassing such displays, for use by users having reduced visual acuity, whereby images ultimately rendered by such devices can be dynamically processed to accommodate the user’s reduced visual acuity so that they may consume rendered images without the use of corrective eyewear, as would otherwise be required. For instance, in some examples, users who would otherwise require corrective eyewear such as glasses or contact lenses, or again bifocals, may consume images produced by such devices, displays and methods in clear or improved focus without the use of such eyewear. Other light field display applications, such as 3D displays and the like, may also benefit from the solutions described herein, and thus, should be considered to fall within the general scope and nature of the present disclosure.

Generally, digital displays as considered herein will comprise a set of image rendering pixels and a LFSL disposed so to controllably shape or influence a light field emanating therefrom. For instance, each light field shaping layer will be defined by an array of optical elements (otherwise referred to as light field shaping elements), which, in the case of LFSL embodiments comprising a microlens array, are centered over a corresponding subset of the display’s pixel array to optically influence a light field emanating therefrom and thereby govern a projection thereof from the display medium toward the user, for instance, providing some control over how each pixel or pixel group will be viewed by the viewer’s eye(s). In some of the herein described embodiments, a vibrating LFSL can result in designation of these corresponding subsets of pixels to vary or shift slightly during any given vibration, for instance, by either allowing some otherwise obscured or misaligned pixels to at least partially align with a given LFSL element, or again, to improve an optical alignment thereof so to effectively impact and/or improve illumination thereby of the viewer’s pupil in positively contributing to an improved adjusted image perception by the viewer.

As will be further detailed below, a LFSL vibration may encompass different displacement or motion cycles of the LFSL relative to the underlying display pixels, such as linear longitudinal, lateral, or diagonal motions or oscillations, two-dimensional circular, bi-directional, elliptical motions or cycles, and/or other such motions or oscillations which may further include three-dimensional vibrations or displacement as may be practical within a particular context or application.

As will be further detailed below, arrayed optical elements may include, but are not limited to, lenslets, microlenses or other such diffractive optical elements that together form, for example, a lenslet array; pinholes or like apertures or windows that together form, for example, a parallax or like barrier; concentrically patterned barriers, e.g. cut outs and/or windows, such as a to define a Fresnel zone plate or optical sieve, for example, and that together form a diffractive optical barrier (as described, for example, in Applicant’s copending U.S. Application Serial No. 15/910,908, the entire contents of which are hereby incorporated herein by reference); and/or a combination thereof, such as for example, a lenslet array whose respective lenses or lenslets are partially shadowed or barriered around a periphery thereof so to combine the refractive properties of the lenslet with some of the advantages provided by a pinhole barrier.

In operation, the display device will also generally invoke a hardware processor operable on image pixel data for an image to be displayed to output corrected image pixel data to be rendered as a function of a stored characteristic of the light field shaping layer (e.g. layer distance from display screen, distance between optical elements (pitch), absolute relative location of each pixel or subpixel to a corresponding optical element, properties of the optical elements (size, diffractive and/or refractive properties, etc.), or other such properties, and a selected vision correction parameter related to the user’s reduced visual acuity, or other image perception adjustment parameter as may be the case given the application at hand. While the following examples will focus on the implementation of vision correction solutions and applications, it will be appreciated that the herein described embodiments are not intended to be limited as such, and that other image perception adjustments may also be considered herein without departing from the general scope and nature of the present disclosure.

Image processing can, in some embodiments, be dynamically adjusted as a function of the user’s visual acuity so to actively adjust a distance of a virtual image plane induced upon rendering the corrected image pixel data via the optical layer, for example, or otherwise actively adjust image processing parameters as may be considered, for example, when implementing a viewer-adaptive pre-filtering algorithm or like approach (e.g. compressive light field optimization), so to at least in part govern an image perceived by the user’s eye(s) given pixel-specific light visible thereby through the layer.

Accordingly, a given device may be adapted to compensate for different visual acuity levels and thus accommodate different users and/or uses. For instance, a particular device may be configured to implement and/or render an interactive graphical user interface (GUI) that incorporates a dynamic vision correction scaling function that dynamically adjusts one or more designated vision correction parameter(s) in real-time in response to a designated user interaction therewith via the GUI. For example, a dynamic vision correction scaling function may comprise a graphically rendered scaling function controlled by a (continuous or discrete) user slide motion or like operation, whereby the GUI can be configured to capture and translate a user’s given slide motion operation to a corresponding adjustment to the designated vision correction parameter(s) scalable with a degree of the user’s given slide motion operation. These and other examples are described in Applicant’s co-pending U.S. Pat. Application Serial No. 15/246,255, the entire contents of which are hereby incorporated herein by reference.

For instance, a display device may be configured to render a corrected image via the light field shaping layer that accommodates for the user’s visual acuity. By adjusting the image correction in accordance with the user’s actual predefined, set or selected visual acuity level, different users and visual acuity may be accommodated using a same device configuration. That is, in one example, by adjusting corrective image pixel data to dynamically adjust a virtual image distance below/above the display as rendered via the light field shaping layer, different visual acuity levels may be accommodated.

However, for any viewing angle of a light field display, there may be some pixels of the pixel array that are located near the periphery of a light field shaping element and for which emitted light may thus be, at least partially, attenuated or blocked, or at least, be positioned so not to effectively benefit from the light field shaping function of this microlens and thus, fail to effectively partake in the combined formation of an adjusted image output. Accordingly, this misalignment may have the effect of reducing the perceived resolution of the light field display when viewed by a user.

While dynamic light field shaping layers as herein described may comprise any one or more of various light field shaping elements (e.g. a parallax barrier, apertures, etc.), the following example a light field display comprises a vibrating microlens array, which, in some implementations, may improve the perceived resolution and consequently provide for a better overall user experience.

For example, as illustrated in FIGS. 9A and 9B in accordance with one embodiment, vibration means such as one or more actuators, drivers or similar may be attached or otherwise operatively coupled to microlens array 800 so as to rapidly oscillate or vibrate microlens 802 over a slightly different subset of pixels in display 804 over a given time period. FIGS. 9A and 9B show the microlens array being moved in a linear fashion further to the right (FIG. 9A) and to the left (FIG. 9B) along one of the principal axes of the underlying pixel array, so as to temporarily address additional pixels 865 and 868 respectively. The light rays emitted from these pixels in the direction of the user’s pupil would otherwise have been obstructed or attenuated due to their relative position with respect to microlens 802 and the user’s pupil, or in the case of transparent transition zones between pixels, fail to adequately benefit from the light field shaping function of the lenslet 802. Likewise, bordering pixels may, as a result of this vibration, benefit from improved alignment with their overlying lenslet and thus reduce optical aberrations related thereto. Other optical and resolution improvements may also be provided, as will be appreciated by the skilled artisan.

For instance, by rapidly moving or oscillating each microlens over the pixel array in a way that is generally too fast for the user to notice, it may be possible to add or better include a contribution from these pixels to the final image perceived by the user and thus increase the perceived resolution. While the user would not typically perceive the motion of the microlens array per se, they would perceive an aggregate of all the different microlens array positions during each cycle, for example, for each light field frame rendered (i.e. where a LFSL vibration frequency is equal or greater than, for example, 30 Hz, or again closer or even above a refresh rate of the display (e.g. 60 Hz, 120 Hz, 240 Hz, or beyond). It is generally understood that the microlens only need to be displaced over a small distance, which could be, for example, as small as the distance between two consecutive pixels in some embodiments (e.g. around 15 microns for a digital pixel display like the Sony™ Xperia™ XZ Premium phone with a reported screen resolution of 3840 ×2160 pixels with 16:9 ratio and approximately 807 pixel-per-inch (ppi) density).

While this example is provided within the context of a microlens array, similar structural design considerations may be applied within the context of a parallax barrier, diffractive barrier or combination thereof.

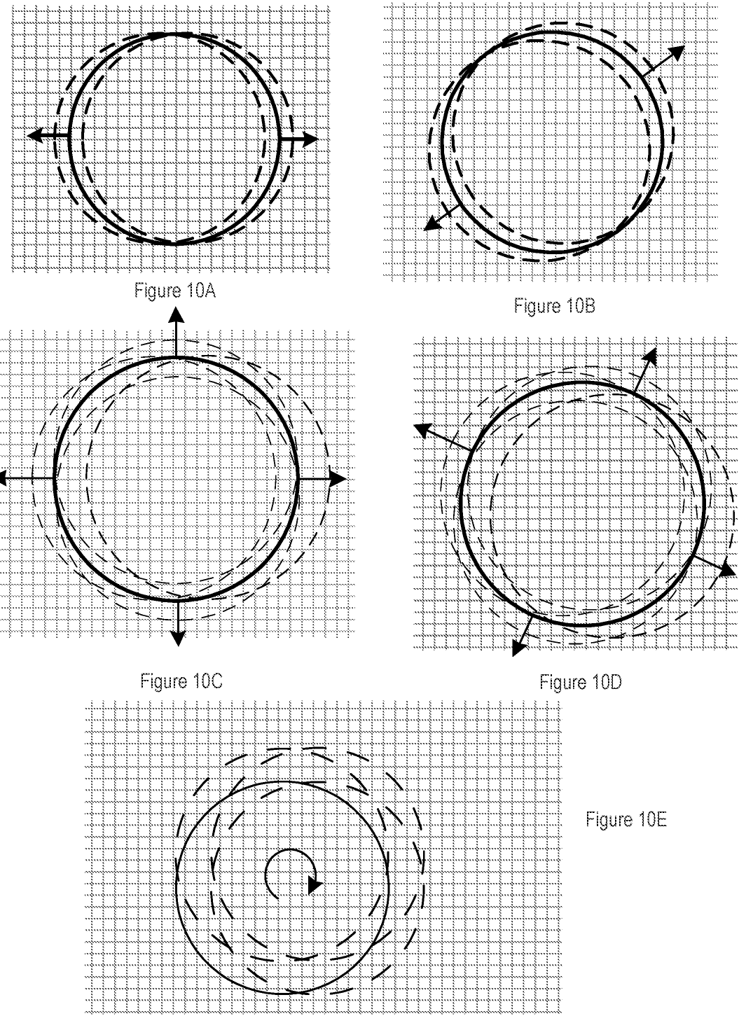

With respect to FIGS. 10A to 10E, and in accordance with one embodiment, different examples of microlens oscillatory motions are described. Each of these figures illustrate a relative motion of a microlens with respect to the underlying pixel array. Note that the relative displacement of the microlens array illustrated herewith with respect to the pixel array has been exaggerated for illustrative purposes only. As discussed above, the oscillatory motion may be a linear motion along one of the principal directions of the pixel array (e.g. along a row of pixels), as seen in FIG. 10A, or at an angle as seen in FIG. 10B. The microlens array may also be made to oscillate bidirectionally, for example along the principal directions of the pixel array, as seen in FIG. 10C, or again at an angle as seen in FIG. 10D. Furthermore, the motion may not be limited to linear motion, for example, as seen in FIG. 10E, circular or ellipsoidal oscillatory motions may be used.

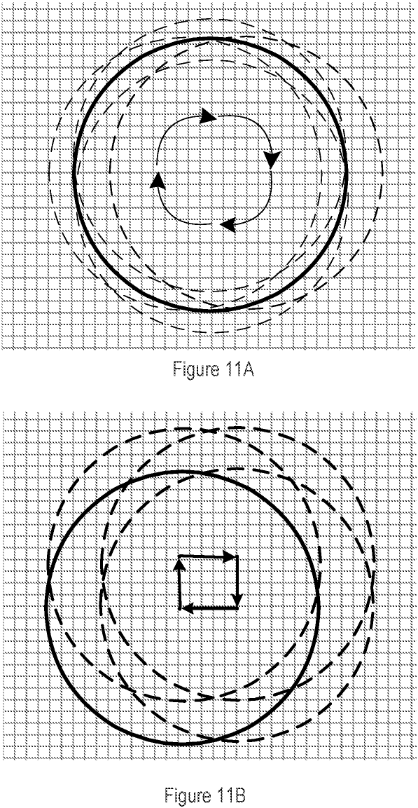

In some embodiments, as illustrated in FIGS. 11A and 11B, more complex oscillatory motions may be considered. For example, instead of a continuous oscillatory motion, as discussed above, the oscillations may be done in a step-wise fashion by moving rapidly the microlens array through a periodic ordered sequence of one or more intermediary positions. As discussed above, in some embodiments, these may also be timed or synchronized with the rendering algorithm so that at each frame each microlens is positioned at a one of the intermediary pre-determined location, or again, that each frame benefit from two or more of these intermediary positions. In the examples of FIGS. 11A and 11B, we see the motion of a single microlens over a pixel array, wherein the microlens is moved to three different locations over the pixel array before returning to its initial position. These displacements may be done in a sequence of linear intermediary displacements (FIG. 11B) or using circular or ellipsoidal displacements (FIG. 11A). These displacements need to be done fast enough so not to be perceived by the user. For example, in one embodiment, the microlens array may be positioned at each of the four different positions illustrated herein thirty times per second for a digital display refreshing at 120 Hz.

In some embodiments, the microlens array may also be made to oscillate perpendicularly to the pixel display, at least in part, by adding a depth component to the motion (e.g. going back and forth relative to the display).

In some embodiments, motion, or fast periodic motion or oscillations of the microlens array, is provided via one or more actuators. Different types of actuators may include, for example, but are not limited to, piezoelectric transducers or motors like ultrasonic motors or the like. Other driving techniques may include, but are not limited to, electrostatic, magnetic, mechanical and/or other such physical drive techniques. One or more means may be affixed, attached or otherwise operatively coupled to the microlens array, at one or more locations, to ensure precise or predictable motion. In some embodiments, the actuators or the like may be integrated into the display’s frame so as to not be visible by the user. In some embodiments, more complex oscillatory motions may be provided by combining two or more linear actuators/motors, for example.

In some embodiments, the actuators may be controlled via, for example, a control signal or similar. For example, square, triangular, or sinusoidal signals, and/or a combination thereof, may be used to drive the actuators or motors. In some embodiments, the control signal may be provided by the display’s main processor, while in other cases, the system may use instead a second digital processor or microcontroller to control the actuators. In all cases, the oscillatory motion may be independent from or synchronized with a light field rendering algorithm, non-limiting examples of which will be discussed below.

Further, movement of a LFSL may be enabled by a means that is alternative to or in addition to an actuator. For instance, a LFSL may be coupled with a robotic arm or other structure operable to provide 1D, 2D, or 3D movement of the LFSL. Regardless of the complexity of the structure enabling movement, a LFSL, in accordance with various embodiments, may move or oscillate in, for instance, one or more of three axes. In such embodiments, movement may be characterised, for instance, by a frequency and/or amplitude in each axis (e.g. by a three-dimensional waveform).

Movement or oscillation may, in accordance with various embodiments, further be employed as a compensation measure to correct for or cancel other motion effects. For instance, a MVD system in a car may be subject to consistent and/or predictable motion or oscillation that arises when driving, that may be sensed or otherwise determined. The MVD system may be operable to receive a signal representative of this motion, and translate a LFSL, for instance via a robotic arm or actuators, at a particular frequency and amplitude in one or more dimensions to effectively dampen or cancel the effects of the MVD or car movement. For instance, LFSL movement may be responsive to (e.g. a negative function of) a background oscillation, or may be tuned to a designated dampening frequency, so to stabilise one or more view zones. In accordance with various embodiments, a sensing element for detecting, characterising, and/or quantifying such ambient vibration, oscillation, or movement may be incorporated within, or operably coupled to (e.g. in network communication with) a MVD system to provide a signal representative of motion. The signal may, in various embodiments, be variable, and/or representative of a consistent motion, and may be one which may be input into, for instance, an oscillation dampening process (e.g. a dampening ratio process employed by a MVD for a ray tracing calculation, displaying distinct content in a plurality of views, or other applications).

In addition to mechanical oscillations provided from, for instance, servo motors, stepper motors, and the like, oscillations or other forms of movement, in accordance with various embodiments, may be digital in nature. For instance, a MVD light field shaping layer may comprise a digital component (e.g. a LCD-based parallax barrier). Movement, vibration, oscillation, and the like, may be provided in the form of digitally simulating a movement of light field shaping elements, such as by the activation of adjacent dark pixels in a particular sequence that mimics motion of a barrier. Such embodiments may further relate to, for instance, high density pixel arrays on a front panel LCD acting as a dynamic, software-controllable digital barrier for pixels of a display screen disposed relative thereto. Such a panel may, and in accordance with some embodiments, allow for refined control over a light field shaping layer or element, and may provide the perceptive effects that may otherwise be generated by a physical movement.

Further embodiments contemplated herein relate to oscillating pixel activation of a display screen. That is, while the abovementioned embodiments relate to oscillation of a light field shaping layer disposed between a user and a pixelated display, or the simulation of a movement through coordinated pixel activation in a digital light field shaping layer, similar results may be enabled by simulating an oscillation of image-producing pixels through the activation of appropriate pixels in specific sequences or patterns at high refresh rates while maintaining a stationary light field shaping layer. Naturally, further embodiments may relate to oscillating, either mechanically or digitally, both a light field shaping layer and light-producing pixels of a display, in coordination, to produce a preferred oscillation pattern and/or optical effect.

Yet other embodiments relate to volumetric displays with a plurality of layers (e.g. N layers) for producing oscillating or stationary image and/or video effects. Such displays may offer, for instance, 3D effects, or may be used for spectral data or in other applications.

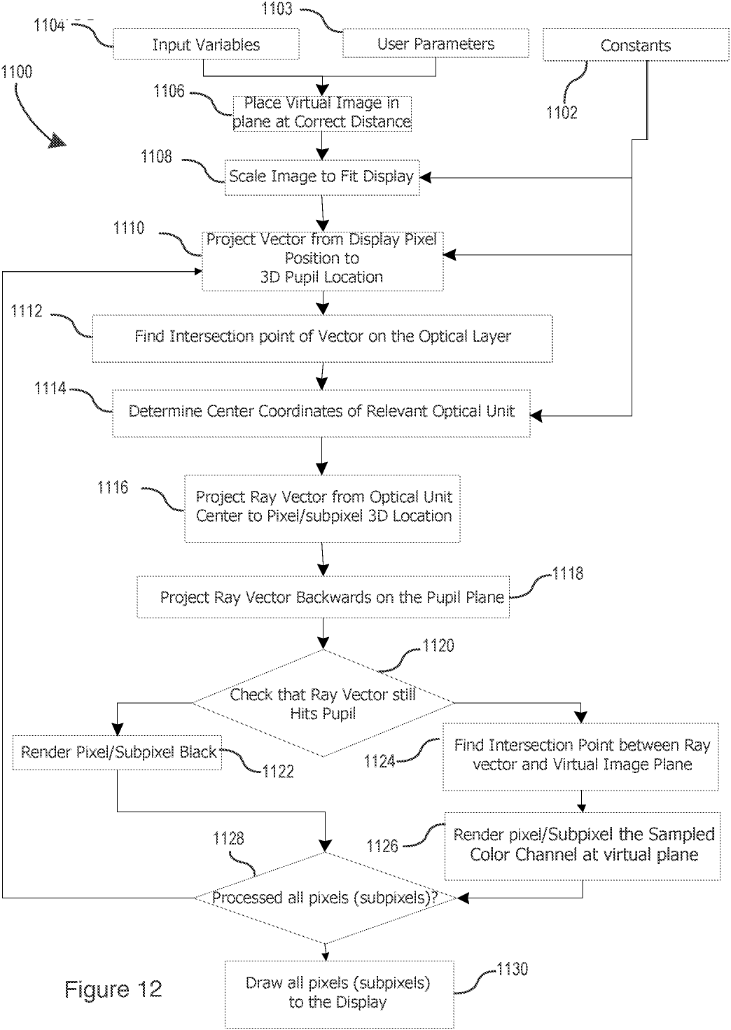

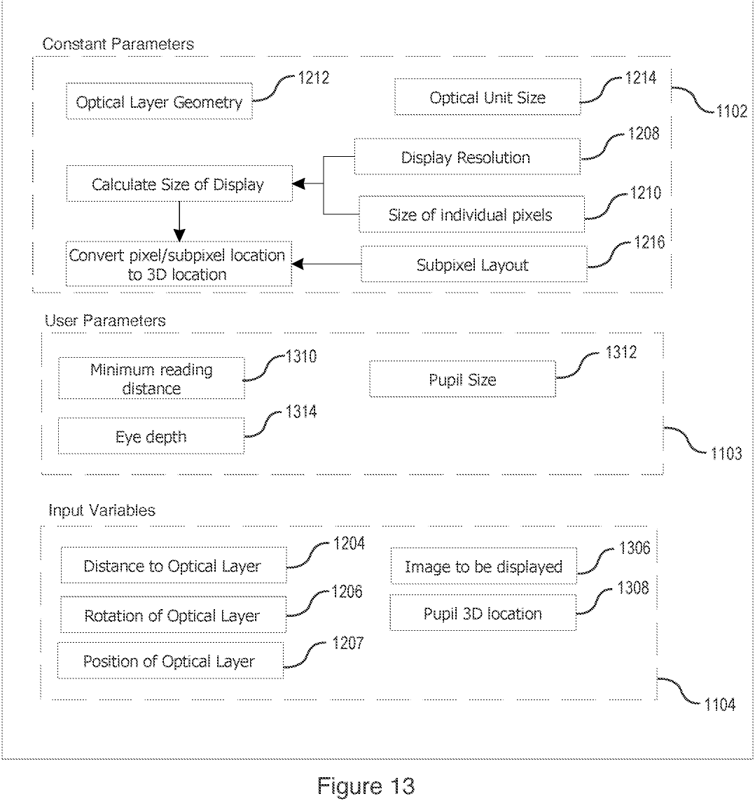

With reference to FIGS. 12 and 13, and in accordance with one embodiment, an exemplary, computationally implemented, ray-tracing method for rendering an adjusted image perception via an oscillating dynamic light field shaping layer (LFSL), for example a computationally corrected image that accommodates for the user’s reduced visual acuity, will now be described. In this exemplary embodiment, a set of constant parameters 1102 and user parameters 1103 may be pre-determined. The constant parameters 1102 may include, for example, any data which are generally based on the physical and functional characteristics of the display (e.g. specifications, etc.) for which the method is to be implemented, as will be explained below. The user parameters 1103 may include any data that are generally linked to the user’s physiology and which may change between two viewing sessions, either because different users may use the device or because some physiological characteristics have changed themselves over time. Similarly, every iteration of the rendering algorithm may use a set of input variables 1104 which are expected to change at each rendering iteration.

As illustrated in FIG. 13, the list of constant parameters 1102 may include, without limitations, the display resolution 1208, the size of each individual pixel 1210, the optical LFSL geometry 1212, the size of each optical element 1214 within the LFSL and optionally the subpixel layout 1216 of the display. Moreover, both the display resolution 1208 and the size of each individual pixel 1210 may be used to pre-determine both the absolute size of the display in real units (i.e. in mm) and the three-dimensional position of each pixel within the display. In some embodiments where the subpixel layout 1216 is available, the position within the display of each subpixel may also be pre-determined. These three-dimensional location/positions are usually calculated using a given frame of reference located somewhere within the plane of the display, for example a corner or the middle of the display, although other reference points may be chosen. Concerning the optical layer geometry 1212, different geometries may be considered, for example a hexagonal geometry.

FIG. 13 also shows an exemplary set of user parameters 1103 for method 1100, which includes any data that may change between sessions or even during a session but is not expected to change in-between each iteration of the rendering algorithm. These generally comprise any data representative of the user’s reduced visual acuity or condition, for example, without limitation, the minimum reading distance 1310, the eye depth 1314 and an optional pupil size 1312. In the illustrated embodiment, the minimum reading distance 1310 is defined as the minimal focus distance for reading that the user’s eye(s) may be able to accommodate (i.e. able to view without discomfort). In some embodiments, different values of the minimum reading distance 1310 associated with different users may be entered, for example, as can other adaptive vision correction parameters be considered depending on the application at hand and vision correction being addressed. In some embodiments, the minimum reading distance 1310 may also change as a function of the time of day (e.g. morning vs evening).

FIG. 13 further illustratively lists an exemplary set of input variables 1104 for method 1100, which may include any input data fed into method 1100 that is expected to change rapidly in-between different rendering iterations, and may thus include without limitation: the image(s) to be displayed 1306 (e.g. pixel data such as on/off, colour, brightness, etc.), and any LFSL characteristics which may be affected by the rapid oscillatory motion of the LFSL, for example the distance 1204 between the display and the LFSL, the in-plane rotation angle 1206 between the display and LFSL frames of reference and the relative position of the LFSL with respect to the underlying pixel array 1207. In the case where any of these variables are static (e.g. not oscillating) they should then be considered constant parameters. In some embodiments wherein the oscillating microlens array and the light field rendering algorithm act independently of each other, the rendering algorithm may use for parameters 1204, 1206 and 1207 a single value representative of a single position of each microlens along the periodic trajectory, or use an averaged position/angle/distance along a full period, for example. By combining the distance 1204, the rotation angle 1206, and the geometry 1212 with the optical element size 1214, it is possible to similarly determine at every iteration the three-dimensional location/position of each optical element center with respect to the display’s same frame of reference.

The image data 1306, for example, may be representative of one or more digital images to be displayed with the digital pixel display. This image may generally be encoded in any data format used to store digital images known in the art. In some embodiments, images 1306 to be displayed may change at a given framerate.

As discussed above, in some embodiments, the actuators may be programmed in advance so that the motion (e.g. any or all of position 1204, rotation angle 1206 or position 1207) of the microlens array may be, for example, synchronized with the pixel display refresh rate. In other embodiments, the control signal may be tuned and changed during operation using a calibration procedure. In other embodiments, additional sensors may be deployed, such as photodiodes or the like to precisely determine the relative position of the microlens array or other light field shaping element(s) as a function of time. Thus, in the event that the microlens array is slightly misaligned with respect to its expected pre-programmed motion, the information provided in real-time from the additional sensors may be used to provide precise positional data to the light field rendering algorithm.

Following from the above-described embodiments, a further input variable includes the three-dimensional pupil location 1308.

The pupil location 1308, in one embodiment, is the three-dimensional coordinates of at least one the user’s pupils’ center with respect to a given reference frame, for example a point on the device or display. This pupil location 1308 may be derived from any eye/pupil tracking method known in the art. In some embodiments, the pupil location 1308 may be determined prior to any new iteration of the rendering algorithm, or in other cases, at a lower framerate. In some embodiments, only the pupil location of a single user’s eye may be determined, for example the user’s dominant eye (i.e. the one that is primarily relied upon by the user). In some embodiments, this position, and particularly the pupil distance to the screen may otherwise or additionally be rather approximated or adjusted based on other contextual or environmental parameters, such as an average or preset user distance to the screen (e.g. typical reading distance for a given user or group of users; stored, set or adjustable driver distance in a vehicular environment; etc.).

Once constant parameters 1102, user parameters 1103 and variables 1104 have been set, the method of FIG. 12 then proceeds with step 1106, in which the minimum reading distance 1310 (and/or related parameters) is used to compute the position of a virtual (adjusted) image plane with respect to the device’s display, followed by step 1108 wherein the size of image 1306 is scaled within the image plane to ensure that it correctly fills the pixel display when viewed by the distant user. In this example, the size of image 1306 in the image plane is increased to avoid having the image as perceived by the user appear smaller than the display’s size.

An exemplary ray-tracing methodology is described in steps 1110 to 1128 of FIG. 12, at the end of which the output color of each pixel of the pixel display is known so as to virtually reproduce the light field emanating from an image 1306 positioned at the virtual image plane. In FIG. 12, these steps are illustrated in a loop over each pixel in the pixel display, so that each of steps 1110 to 1126 describes the computations done for each individual pixel. However, in some embodiments, these computations need not be executed sequentially, but rather, steps 1110 to 1128 may executed in parallel for each pixel or a subset of pixels at the same time. Indeed, as will be discussed below, this exemplary method is well suited to vectorization and implementation on highly parallel processing architectures such as GPUs.

As illustrated in FIG. 12, in step 1110, for a given pixel in the pixel display, a trial vector is first generated from the pixel’s position to the (actual or predicted) center position of the pupil. This is followed in step 1112 by calculating the intersection point of the vector 1413 with the LFSL.

The method then finds, in step 1114, the coordinates of the center of the LFSL optical element closest to the intersection point. Once the position of the center of the optical element is known, in step 1116, a normalized unit ray vector is generated from drawing and normalizing a vector drawn from the center position to the pixel. This unit ray vector generally approximates the direction of the light field emanating from this pixel through this particular light field element, for instance, when considering a parallax barrier aperture or lenslet array (i.e. where the path of light travelling through the center of a given lenslet is not deviated by this lenslet). Further computation may be required when addressing more complex light shaping elements, as will be appreciated by the skilled artisan. The direction of this ray vector will be used to find the portion of image 1306, and thus the associated color, represented by the pixel. But first, in step 1118, this ray vector is projected backwards to the plane of the pupil, and then in step 1120, the method verifies that the projected ray vector is still within the pupil (i.e. that the user can still “see” it). Once the intersection position of projected ray vector with the pupil plane is known, the distance between the pupil center and the intersection point may be calculated to determine if the deviation is acceptable, for example by using a pre-determined pupil size and verifying how far the projected ray vector is from the pupil center.

If this deviation is deemed to be too large, then in step 1122, the method flags this pixel as unnecessary and to simply be turned off or render a black color. Otherwise, in step 1124, the ray vector is projected once more towards the virtual image plane to find the position of the intersection point on the image. Then in step 1126, the pixel is flagged as having the color value associated with the portion of the image at the noted intersection point.

In some embodiments, method 1100 is modified so that at step 1120, instead of having a binary choice between the ray vector hitting the pupil or not, one or more smooth interpolation function (i.e. linear interpolation, Hermite interpolation or similar) are used to quantify how far or how close the intersection point is to the pupil center by outputting a corresponding continuous value between 1 or 0. For example, the assigned value is equal to 1 substantially close to pupil center and gradually changes to 0 as the intersection point substantially approaches the pupil edges or beyond. In this case, the branch containing step 1122 is ignored and step 1120 continues to step 1124. At step 1126, the pixel color value assigned to the pixel is chosen to be somewhere between the full color value of the portion of the image at the intersection point or black, depending on the value of the interpolation function used at step 1120 (1 or 0).

In yet other embodiments, pixels found to illuminate a designated area around the pupil may still be rendered, for example, to produce a buffer zone to accommodate small movements in pupil location, for example, or again, to address potential inaccuracies, misalignments or to create a better user experience.

In some embodiments, steps 1118, 1120 and 1122 may be avoided completely, the method instead going directly from step 1116 to step 1124. In such an exemplary embodiment, no check is made that the ray vector hits the pupil or not, but instead the method assumes that it always does.

Once the output colors of all pixels have been determined, these are finally rendered in step 1130 to be viewed by the user, therefore presenting a light field corrected image. In the case of a single static image, the method may stop here. However, new input variables may be entered and the image may be refreshed at any desired frequency, for example because the user’s pupil moves as a function of time and/or because instead of a single image a series of images are displayed at a given framerate. A framerate or desired frequency may be one that is enabled by a display, and may depend on, for instance, a number of views, screen resolution, type of content (e.g. video, images), processing power, and the like.

These and other ray-tracing methods are described in greater detail in, for instance, Applicant’s U.S. Pat. Nos. 10,394,322 and 10,636,116, the entire contents of each of which are incorporated herein by reference.

While the embodiments described above provide for a dynamic light field shaping layer that may vibrate to improve resolution, and therefore a perception adjustment, for users with reduced visual acuity, movement of a dynamic light field shaping layer (LFSL) may also allow for, for instance, reduced crosstalk between independent views of a multiview display system (MVD). Given the inherent sensitivity of user perception of a view zone of a MVD based on, for instance, their position relative thereto, various embodiments relate to dynamically adjusting the position of a LFSL disposed between a display and a user in one or more dimensions disposed to provide a view zone location(s) that provide a positive experience for one or more users. For instance, various embodiments relate to a LFSL that may be dynamically adjusted in one or more dimensions (i.e. towards/away from a display, left/right relative to a display, and/or up/down relative to a display) to define one or more view zone locations, or number thereof, and may be held static upon configuration for a user session or dynamically adjusted during content viewing.

Conventional static MVD solutions comprise a parallax barrier (PB) disposed on a digital pixel-based screen, such as a liquid crystal display (LCD). In such configurations, PB patterns must be precisely calculated, printed, and aligned with the display. PB specifications (pitch, distance to a screen, distance to a user, etc.) are typically fixed to support a specific rendering pattern (i.e. two views, three views, etc.). While methods and systems are known in the art for, for instance, rendering images for specific viewing locations using specific pixel subsets that can be viewed from designated angles, user movement may result in detrimental effects.

Dynamic PB (dyPB) solutions, on the other hand, are typically constructed using an additional LCD, electrically-actuated, or other like panel disposed between the display and a user, wherein the panel often has a similar overall size and/or aspect ratio as the digital display. While the display presents content media via (typically) RGB pixels, the foremost LCD-based dyPB displays black or otherwise opaque pixels to allow only light rays from certain display pixels to reach a particular user location relative to the display. This may present a challenge in that it is often necessitated that the LCD or other dyPB screen be sufficiently optically clear to maintain quality of images viewed therethrough.

The conventional dyPB may provide variable dark pixel configurations, and therefore dynamic slit widths and arrangements, to accommodate, for instance, a viewer or pupil in a specific position. However, a dyPB LCD screen may, depending on the on the underlying display pixel configuration, require a resolution that is higher (~2-3 times higher) than that of the display in order in order to provide a positive user experience, as barrier adjustment step sizes must be precise enough to avoid introducing a large degree of crosstalk between view zones. Conversely, in cases that the pixel size of a dyPB layer is larger than the RBG pixels of a display, but wherein a proper ratio of pixels is maintained to effectively block RBG pixel light, adjustment of the dyPB, and achieving flexibility thereof, may be challenging. Furthermore, while images can be re-rendered and dyPB slits and barriers reconfigured to accommodate a new user location, such systems often include user tracking devices (see, for instance, U.S. Pat. Application 9294759 B2 entitled “Display device, method and program capable of providing a high-quality stereoscopic (3D) image, independently of the eye-point location of the viewer” and issued to Hirai on Mar. 22, 2016), which may, in addition to being both costly and computationally expensive, present privacy concerns. Further, some systems (e.g. 3D autostereoscopic displays) generate view zones that rigidly match a typical pupillary distance (e.g. 62 mm to 65 mm) in order to provide intended perception effects. Such view zones may be narrow, and may not accommodate user movement without the user experiencing discomfort, which similarly leads to user tracking in situations where it is expected that a user will not remain at a specific location relative to the display.

In accordance with various embodiments, a parallax barrier may be fabricated via various means including, but not limited to, high-resolution photoplotting, etc., with a high degree of precision (e.g. micron or sub-micron precision). For instance, a parallax barrier may be printed on a mylar sheet or equivalent optically transparent material and disposed in front of a display. In accordance with various embodiments, a PB printed with high precision may be coupled with actuators to provide a dynamic light field shaping layer (LFSL) that may be adjusted with high precision while simultaneously providing a high degree of resolution to provide spatially adjustable view zones with minimal crosstalk therebetween. Further, various embodiments relate to a LFSL that may optionally also comprise anti-glare properties, an anti-glare surface and/or coating, and/or a protective coating layer.

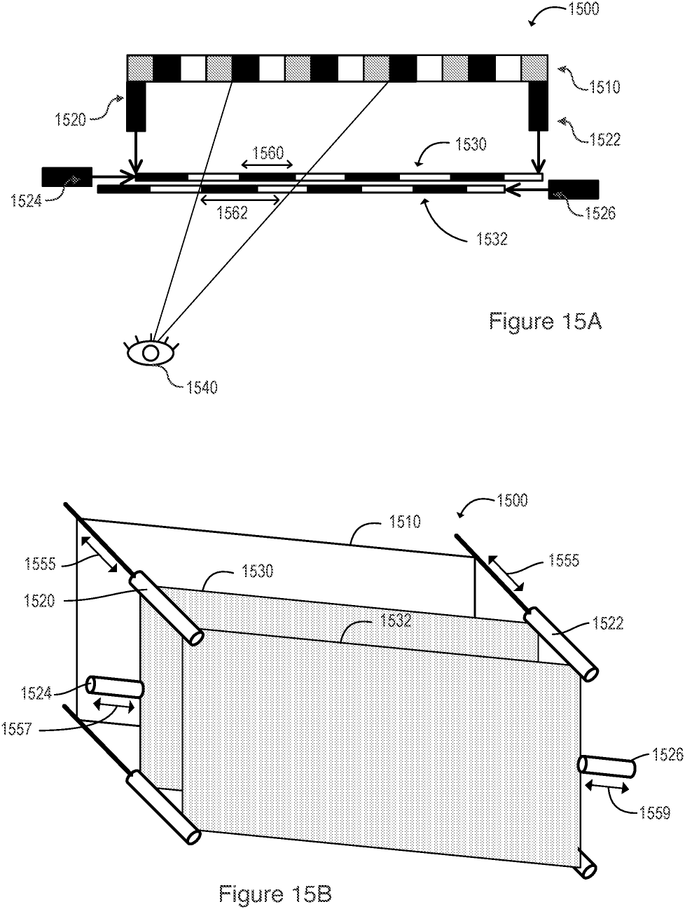

Conventional printed light field shaping layers may be inexpensively printed (e.g. inkjet, laserjet) on a thin, often flexible acetate, mylar, or like sheet which is then glued, adhered using optically clear adhesive, or otherwise mounted on a sheet of glass or other material (i.e. a ‘spacer’) to provide rigidity and a spacing between LFSL features and a display when mounted thereon. Alternatively, large PBs may employ waterjet, laser cutting equipment, and/or injection molding for production of LFSLs from solid materials. Such systems indeed fall within the scope of this disclosure. For instance, dual parallax barriers as described with reference to FIGS. 15A and 15B may comprise individually addressable parallax barriers printed on mylar sheets that are, for instance, 100 microns thick to minimise detrimental effects on quality of viewing. However, various further embodiments relate to printing a light field shaping layer at high resolution on a durable sheet with sufficient rigidity so as to not require bonding or other affixation to, for instance, an additional glass sheet, thus providing space for additional freedom of movement towards/away from a display during dynamic adjustment (i.e. providing an air gap between a LFSL and a display screen). It will be appreciated that a LFSL as herein described may therefore comprise one or more layers. For example, a LFSL may comprise a thin sheet of material on which, for instance, a parallax barrier is printed, as well as a support structure or spacer on which the parallax barrier is disposed to provide a desired rigidity.

On the other hand, while rigidity of a sheet having LFSL features printed thereon may be desirable for maintaining LFSL shape during dynamic adjustment and user viewing, a sheet material with a degree of flexibility may, in accordance with some embodiments, provide for ease of fabrication and assembly (e.g. alignment and mounting on a MVD).

In other preferred embodiments, a LFSL material may be rigid. Such embodiments may, for instance, minimise crosstalk that may occur with flexible sheets adhered to a display. Furthermore, a sheet material that, in the event of a crack or other form of breaking, minimises risk of user injury may be desirable. As such, tempered glass (e.g. Gorilla glass), or other like materials with inherent transparency that provides sufficient thinness (e.g 1-3 mm, although the skilled artisan will appreciate that the thickness of such a layer may scale with its area to maintain rigidity while also providing an air gap between a display and LFSL) to increase range of motion relative to a display, and yet may break in a safe manner, while providing sufficient rigidity to maintain a screen shape during movement and use, may, in accordance with various embodiments, be employed as a substrate on which a dynamic LFSL is printed, etched, or otherwise disposed. Such a material, while potentially more costly and heavier than, for instance, a plexiglass spacer on which a separate LFSL may be disposed, may reduce both the number of layers that require assembly (i.e. provide ease of fabrication), and reduce chances of misalignment of the various components to be mounted on a display (i.e. provide a higher quality consumer product). Further, printing on a substrate such as Gorilla glass may further offer increased transparency, quality, uniformity, and precision as compared to printing on, for instance, an acetate sheet. For instance, the former may inherently or readily provide a preferred combination of a spacer layer, a PB layer, an anti-glare coating layer, and a protecting layer. Conversely, the assembly of these independent components may be problematic and/or costly to perform with high precision for the latter.

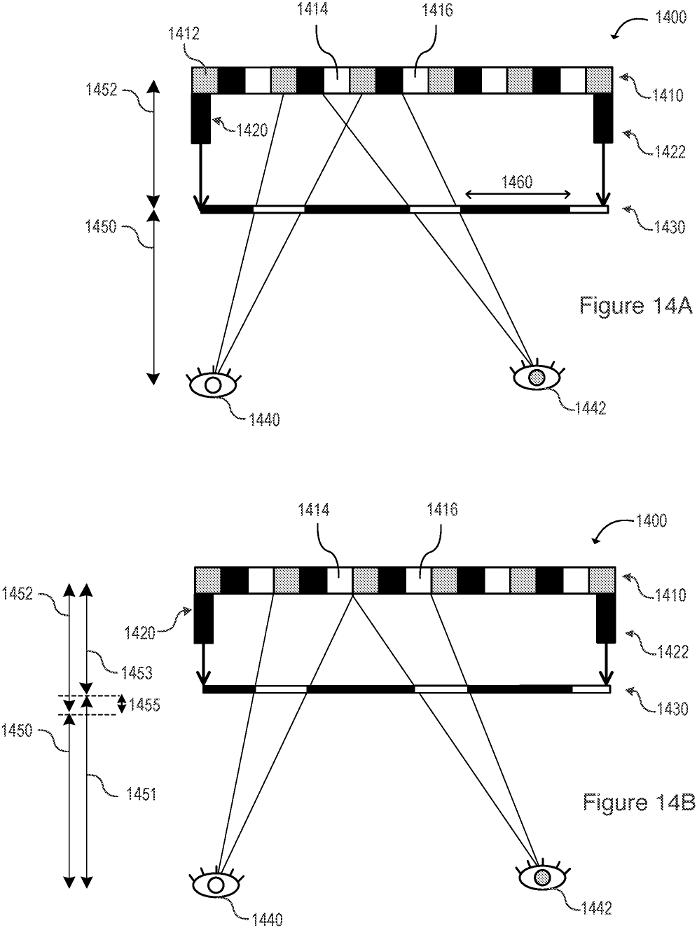

In accordance with various embodiments, a printed dynamic light field shaping layer may be coupled with a display screen via one or more actuators and that may move the LFSL towards or away from (i.e. perpendicularly to) a digital display, and thus control where, for instance, a particular view of a MVD will be located. For instance, FIG. 14A shows a schematic of a multiview display system (not to scale) comprising a digital display 1410 having an array of pixels 1412. In this example, conventional red, green, and blue pixels are shown as grey, black, and white pixels, respectively. In order to provide multiple views, a parallax barrier 1430, coupled to the display 1410 via actuators 1420 and 1422 and having a barrier width (pitch) 1460, is disposed between the display 1410 and two viewing locations 1440 and 1442, represented white and grey eyes, respectively. In accordance with various embodiments, view zones 1440 and 1442 may correspond to, for instance, two different eyes of a user, or eyes of two or more different users.

FIG. 14A shows an arbitrary configuration in which viewing locations 1440 and 1442 are at a distance 1450 from the PB 1430, while the PB 1430 is at a distance 1452 from the screen 1410. Without optimisation, such a configuration will likely lead to a negative viewing experience. For instance, pixel 1414 is visible from both viewing locations 1440 and 1442 (resulting in crosstalk) while pixel 1416 is visible from neither location 1440 nor 1442 (decreased brightness and resolution for both views).

In accordance with various embodiments, actuators 1420 and 1422 may translate the PB towards or away from the display 1410. In FIG. 14B, actuators 1420 and 1422 have reconfigured the MVD system 1400 such that the PB 1430 has been dynamically shifted towards the display 1410 by a distance 1455, resulting in a new distance 1451 between the PB 1430 and viewing locations 1440 and 1442, and a new separation 1453 between the display 1410 and PB 1430. In this more optimised configuration, pixel 1414 is now visible at viewing location 1440 but not location 1442, while pixel 1416 is visible only to a user at location 1442 but not at location 1440. That is, dynamically shifting the PB by a distance 1455 towards the display has provided a configuration in which there is less crosstalk between views.

The skilled artisan will appreciate that various actuators may be employed to dynamically adjust a LFSL with high precision, while having a robustness to reliably adjust a LFSL or system thereof (e.g. a plurality of LFSLs, a LFSL comprising a plurality of PBs, and the like). Furthermore, embodiments comprising heavier substrates (e.g. Gorilla glass or like tempered glass) on which LFSL are printed may employ, in accordance with some embodiments, particularly durable and/or robust actuators, examples of which may include, but are not limited to, electronically controlled linear actuators, servo and/or stepper motors, rod actuators such as the PQ12, L12, L16, or P16 Series from Actuonix^{®} Motion Devices Inc., and the like. The skilled artisan will further appreciate that an actuator or actuator step size may be selected based on a screen size, whereby larger screens may, in accordance with various embodiments, require only larger steps to introduce distinguishable changes in user perception. Further, various embodiments relate to actuators that may communicate with a processor/controller via a driver board, or be directly integrated into a processing unit for plug-and-play functionality.

While FIGS. 14A and 14B show a dynamic adjustment of a LFSL layer in a direction perpendicular to the screen to minimise crosstalk at a particular viewing distance, the skilled artisan will appreciate that such perpendicular adjustments (i.e. changing the separation 1453 between the display 1410 and LFSL 1430) results in a modification of an optimal viewing distance 1451 from the LFLS 1430. As such, the separation 1453 may be adjusted to configure a system 1400 for a wide range of preferred viewing positions.

Furthermore, as readily available actuators can finely adjust and/or displace the high-resolution printed PB 1430 with a high degree of precision (e.g. micron-precision), the inherent sacrifices of resolution and crosstalk based on the dyPB step size in conventional systems relying on the activation of pixels on a LCD PB are mitigated, in accordance with various embodiments. As such, various embodiments of a dynamic light field shaping layer (LFSL) as herein described relate to one or more high-resolution printed parallax barriers that may be translated perpendicularly to a digital display to enhance user experience.

It will be appreciated that while FIGS. 14A and 14B comprise two actuators 1420 and 1422, one on each side of the LFSL 1430, various embodiments comprise other numbers of actuators operable to displace the LFSL 1430. For example, various embodiments relate to the use of four actuators coupling a LFSL 1430 with a display screen 1410, wherein one actuator is disposed at each corner of the LFSL 1430 and/or display 1410. In accordance with other embodiments, such actuators may be disposed along an edge of the LFSL 1430 or display 1410 (e.g. at the midpoint of each edge of the LFSL 1430 or display 1410). It will further be appreciated that such actuators may be independently addressable (e.g. each actuator may be operated independently, pairs of actuators may be operable in unison, or the like).

One embodiment relates to a multiview display system comprising two actuators 1420 on the left-hand side of a display (e.g. in the top-left and bottom-left corners), and two actuators 1422 on the right-hand side of the display (e.g. in the top-right and bottom-right corners of the display). Actuators 1420 and 1422 may, in one embodiment, be electronically activated, although it will be appreciated that other embodiments relate to manually activated actuators. Such actuators may be linearly scaled/operated to adjust the spacer distance 1452 between the active display 1410 and the parallax barrier 1430. Indeed, instead of employing a fixed LFSL position at a distance 1452 from a display screen, which may result in crosstalk or other artifacts, linear actuators may allow for fine adjustment (e.g. hundreds of microns to several millimetres) of the LFSL position to place the LFSL at a preferred location where, for instance, two different viewers 1440 and 1442 located at different positions with respect to the display may experience reduced crosstalk between views.

In accordance with one embodiment, such a multiview display system may relate to a screen size that is approximately 27″. For such a screen size, a LFSL may comprise a plexiglass spacer on which a PB is printed, wherein the LFSL has sufficient rigidity and is sufficiently lightweight to experience minimal warping when in use.

However, for larger display systems, a LFSL with increased rigidity may be preferred. Accordingly, various embodiments relate to systems having a LFSL comprising glass or another more rigid material. However, such LFSLs may be too heavy for the actuators preferred for lightweight systems. Accordingly, various embodiments relate to a multiview system with a LFSL that is dynamically adjustable using alternative means.

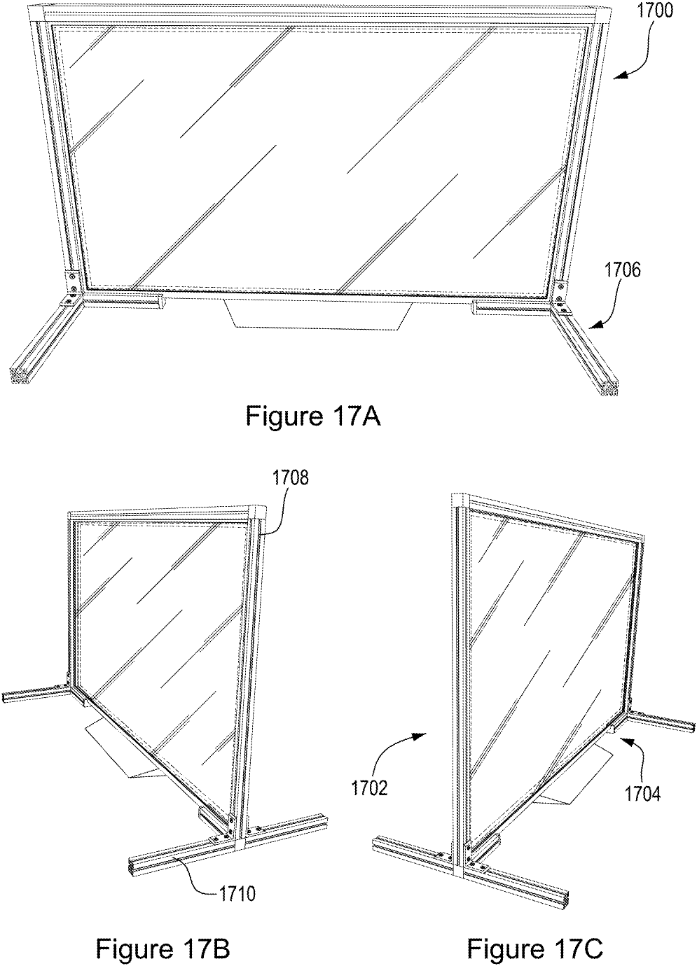

For example, FIGS. 17A to 17C illustrate an exemplary multiview display system 1700 comprising a 55″ display screen 1702 (shown in stippled lines) and a corresponding LFSL 1704 comprising tempered glass. In this example, due to the weight of the LFSL 1704, it is mounted on a LFSL holder 1706 comprising a vertical support structure 1708 that is in turn mounted on a horizontal track 1710. In accordance with some embodiments, the position of the LFSL 1704 may be adjusted along the track 1710 to provide high quality viewing zones for one or more viewers of the system while minimising visual artifacts and improving user experience. For example, the LFSL holder 1706 may comprise motorised actuators (e.g. linear servo motors, not shown) that may be activated using a television remote control to adjust the position of LFSL 1704 and/or vertical support structure 1708. Accordingly, and in accordance with some embodiments, a user may be seated on a couch and may adjust a LFSL 1704 position as one may conventionally adjust a television volume until they are satisfied with a viewing experience. In accordance with other embodiments, the display screen 1702 and LFSL 1704 may comprise a single standalone multiview display system 1700 that is calibrated for, for instance, a particular room and/or user configuration. For example, the large multiview display system 1700 of FIGS. 17A to 17C may have a LFSL layer 1704 position relative to the display screen 1702 adjusted and fixed with screws or other fastening means based on the position of the system 1700 relative to a seating configuration of the room in which it is used. A LFSL as herein disclosed, in accordance with various embodiments, may further or alternatively be dynamically adjusted in more than one direction. For instance, in addition to providing control of the distance between a display (e.g. MVD) and a single LFSL (e.g. a single parallax barrier) oriented substantially parallel thereto, the LFSL may further be dynamically adjustable in up to three dimensions. The skilled artisan will appreciate that actuators, such as those described above, may be coupled to displace any one LFSL, or system comprising a plurality of light field shaping components, in one or more directions. Yet further embodiments may comprise one or more LFSLs that dynamically rotate in a plane of the display to, for instance, change an orientation of light field shaping elements relative to a pixel or subpixel configuration. For example, a PB that is not parallel to a display screen (e.g. tilted such that one edge of a LFSL is closer to a display screen than another edge) may give rise to undesirable visual artifacts or an unpleasurable viewing experience. Actuators disposed at, for instance, the four corners of a rectangular LFSL and/or display screen may be independently actuated to adjust the LFSL orientation such that it is more substantially aligned parallel to the display screen, in accordance with one embodiment.

In addition to providing control over the distance between a parallax barrier and a screen, a LFSL as herein described may further allow for dynamic control of a PB pitch, or barrier width. In accordance with various further embodiments, a light field shaping system or device may comprise a plurality of independently addressable parallax barriers. For instance, FIG. 15A shows a schematic of a MVD system 1500 comprising a digital display 1510 operable to render a plurality of views to respective locations using a dynamically adjustable dual parallax barrier system. In this example, a first parallax barrier 1530 is disposed in front of a display 1510 and coupled to actuators 1520 and 1522 operable to displace the LFSL in a direction perpendicular to the display, as discussed above with reference to FIGS. 14A and 14B and shown as arrows 1555 in FIG. 15B. However, in this and similar embodiments, the PB 1530 is further coupled to one or more lateral actuators 1524 operable to displace the PB 1530 laterally (i.e. in a direction parallel to the display 1510, as shown by arrow 1557), based on, for instance, a particular user location or distribution of user locations.

In this example, the system 1500 comprises a second PB 1532, which in turn is independently addressable by one or more lateral actuators 1526 to move the second PB 1532 laterally 1559 relative to the display 1510 and/or first PB 1530. In this case, while PBs 1530 and 1532 each have a barrier width 1560, a user at a viewing location 1540 experiences an effective barrier width 1562 that is greater than the individual width 1560 of either of the PBs 1530 or 1532. As a result, the viewer at location 1540 does not receive light emitted from repeating clusters of six pixels. Conversely, with an otherwise similar configuration such as that of FIG. 14B with a single barrier, a slit width 1560 would block fewer pixels for a user as position 1540.

The skilled artisan will appreciate that while the parallax barriers 1530 and 1532 of FIGS. 15A and 15B show independently addressable PBs of the same barrier width 1560, different PBs within a system may comprise different pitches (barrier widths). Furthermore, one or more of a plurality of PBs within a system may be stationary with respect to one or more system components. For instance, while the PB 1530 may be disposed at a fixed lateral position relative to the display 1510 and coupled thereto (or to an anchor point stationary relative thereto) via actuators operable to displace PB 1530 in a direction perpendicular to the display 1510, the PB 1532 may be coupled to one or more actuators to be displaced in one or more directions parallel to the display and/or stationary PB 1530. Yet other embodiments comprise a plurality of PBs wherein any one PB, a combination thereof, or all PBs may be dynamically adjusted in one or more dimensions relative to the display 1510 or another element of the system.

While FIGS. 15A and 15B show one actuator per parallax barrier to provide lateral movement thereof relative to the display screen 1510, the skilled artisan will appreciate that more than one actuator may be employed or coupled to one or more sides of a PB to provide, for instance, improved stability, precision, alignment, and the like.

Furthermore, in order to minimise the gap between PBs 1530 and 1532, and thus minimise any detrimental effects on the quality of a MVD system or user experience, substrates may be assembled with respective LFSL sides facing one another (i.e. assembled with printed PBs being the inner surfaces in stacked PB systems).

Further embodiments relate to a system comprising a plurality of PBs, one or more of which may be dynamically adjustable in a direction parallel to the display 1510. In some embodiments, a system of PBs may be coupled to one or more actuators operable to displace the system of PBs in a direction perpendicular to the display 1510.

Furthermore, while the PBs 1530 and 1532 in FIGS. 15A and 15B show linear actuators 1520, 1522, 1524, and 1526 for displacement in two dimensions, the skilled artisan will appreciate that additional and/or alternative actuators may be included to displace one or more of the PBs 1530 and 1532 in a third dimension, or to rotate a LFSL system about an axis normal to the display 1510. Furthermore, various embodiments relate to actuators that may be employed in various combinations to adjust either a LFSL as a whole or one or more constituent components thereof. For instance, a LFSL comprising two parallax barriers may be configured to move as a unit in a direction perpendicular to a display via one or more actuators, while the parallax barriers may independently be adjusted in a direction parallel to a display with respective additional actuators. Alternatively, a LFSL comprising two parallax barriers may have a first parallax barrier that is stationary relative to a display, while the second parallax barrier may be moved relative thereto via actuators in one or more dimensions. In yet further exemplary embodiments, all parallax barriers or other elements of a LFSL may be independently addressable in any (or all) desired dimension(s).

Furthermore, while 1D parallax barriers are generally described herein, one or more 2D parallax barriers, such a pinhole arrays, may be used and actuated to impact corresponding view in one to three dimensions. Such 1D or 2D parallax barriers may be used in combination, as can other types of LFSL be considered, such as microlens arrays and hybrid barriers, to name a few examples.

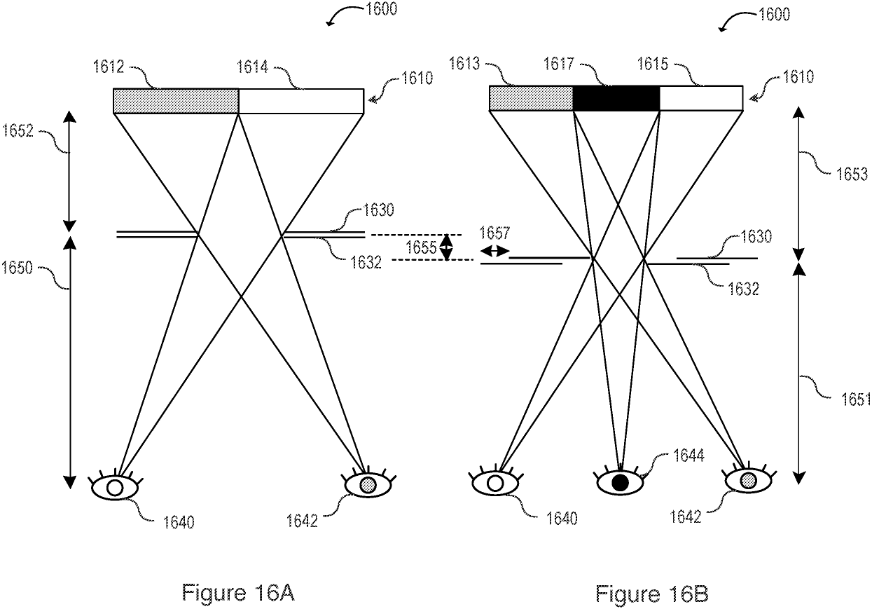

As an exemplary application of a dynamic light field shaping layer system, FIGS. 16A and 16B show various embodiments that may relate to changing the number of views of a MVD through dynamically adjusting both the distance between a display and a LFSL system, and the barrier width of the LFSL. In this example, FIG. 16A shows a dual dynamic parallax barrier system 1600 wherein two parallax barriers 1630 and 1632 comprise barriers of the same width that are disposed at a distance 1652 from a digital display 1610. In this example, two desired view zones 1640 and 1642 are situated at a distance 1650 from the dual parallax barriers 1630 and 1632. With the parallax barriers 1630 and 1632 disposed so to have completely overlapping barrier portions, a first region of pixels 1614 of the display 1610 is visible from the first view zone 1640, and a second region of pixels 1612 of the display 1610 is visible from the second view zone 1642, with minimal crosstalk between view zones. With such a system configuration, a distinct third view zone could not be rendered on the display 1610 without introducing a significant amount of crosstalk between viewing zones.

However, FIG. 16B shows the system 1600 having parallax barriers 1630 and 1632 that have been dynamically adjusted by, for instance, actuators as described above. This exemplary adjustment both increased the separation 1653 between the display 1610 and the PBs 1630 and 1632 by a distance 1655 relative to the separation 1652 of FIG. 16A (and therefore decreased the distance 1651 between users and the parallax barrier system), and increased the effective barrier width of the system by a distance 1657. In this example, the view zones 1640 and 1642 have remained stationary with respect to the display 1610 and are able to receive display content from pixel regions 1615 and 1613, respectively. However, a third viewing location 1614 is now able to view a respective region of pixels 1617 on the display 1610, with minimal crosstalk between any pixel regions corresponding to different view zones.

While user positions 1640, 1642, and 1644 in FIG. 16B relate to a common user distance 1651 from the PBs 1630 and 1632, the skilled artisan will appreciate that various embodiments are not so restricted. For instance, the ability to dynamically adjust an effective barrier width (e.g. width 1562 in FIG. 15B), as well as the ability to translate a LFSL towards/away, or from left to right, relative to a display, as herein described, may enable system configurations that allow for a plurality of users at various distances to simultaneously view a MVD with a sufficiently high resolution and acceptably low level of crosstalk (view blending) to maintain a positive user experience.

More generally, various embodiments relate to a dynamic light field shaping layer system in which a system of one or more LFSLs may be incorporated on an existing display operable to display distinct content to respective view zones. Such embodiments may, for instance, relate to a clip-on solution that may interface and/or communicate with a smart TV or digital applications stored thereon, either directly or via a remote application (e.g. a smart phone application) and in wired or wireless fashion. Such a LFSL may be further operable to rotate in the plane of a display via, for instance, actuators as described above, to improve user experience by, for instance, introducing a pitch mismatch offset between light field shaping elements and an underlying pixel array. Such embodiments therefore relate to a LFSL that is dynamically adjustable/reconfigurable for a wide range of existing display systems (e.g. televisions).

Some embodiments relate to a standalone light field shaping system in which a multiview display television (MVTV) unit comprises a LFSL and smart display (e.g. a smart TV display having a LFSL disposed thereon). Such systems may comprise inherently well calibrated components (e.g. LFSL and display aspect ratios, LFSL elements and orientations appropriate for a particular display pixel or subpixel configuration, etc.).

Whether detachable from a display system, or a constituent component of a standalone dynamically adjustable MVTV, various embodiments of a LFSL relate to a disposition of LFSL features that is customised for a particular display screen. For example, while a display screen may have nominal specifications of pixel width, orientation, or the like, typically referenced as uniform measures or metrics generally representative of the pixel distribution, on average, the actual specifications of a screen may differ due to, for instance, screen fabrication processes. This may manifest as, for instance, pixels nearer to the edge of a display screen being less uniformly distributed, or disposed in configurations that deviate from a vertical or horizontal axis. Accordingly, a completely periodic LFSL, or one designed with respect to nominal, and generally uniform, screen specifications, may result in an undesirable viewing experience, even if a LFSL were dynamically adjustable to improve a quality of viewing for a particular viewing location(s). Various embodiments, however, may account for such imperfections in screen configurations through the inclusion of a LFSL (e.g. a parallax barrier) that is customised to the specific pixel configuration of a display screen, that is, to account for a relative nonuniformity (e.g. variable pitch, disposition, configuration, shape, size, etc.) of the pixel distribution in at least some regions of the display.

For example, and without limitation, various systems and methods described herein provide, in accordance with various embodiments, LFSLs that are customised based on a measured actual pixel configuration of a display screen so to accommodate any potentially impactful nonuniformities, which would otherwise result in a partial mismatch/misalignment between the LFSL and display pixels. For instance, one embodiment relates to obtaining a high magnification image of one or more regions of a display screen to determine an actual pixel configuration and/or spacing and thus identify any pixel distribution non-uniformities across the display surface. A LFSL fabricated to match the actual nonuniform pixel distribution of the screen (e.g. a printed PB) may then be provided as a clip-on solution or as part of a standalone MVTV, wherein the quality of one or more view zones resulting from the LFSL may be improved as compared to that generated using a generic LFSL. In accordance with yet another embodiment, a digital LFSL (e.g. an LCD screen operable to render specific pixels or rows thereof opaque, while others remain transparent) may render customised patterns of LFSL features (e.g. barriers) that correspond to the specific measured or otherwise known configuration of display screen pixels.

It will be appreciated that such embodiments may further relate to adjusting and/or translating the position/orientation of the LFSL using one or more actuators, as described above. For example, and without limitation, a customised PB may be rotated in a plane parallel to a display screen via one or more actuators so to align the customised barriers with the particular pixel configuration of the display screen. Similarly, the customised LFSL may be adjusted to increase the degree to which the LFSL is parallel to the display screen, or to adjust a distance between the screen and the LFSL, to better accommodate one or more viewing locations.

In either a detachable LFSL device or standalone dynamically adjustable MVTV, various systems herein described may be further operable to receive as input data related to one or more view zone and/or user locations, or required number thereof (e.g. two or three view zones). For instance, data related to a user location may be entered manually or semi-automatically via, for example, a TV remote or user application (e.g. smart phone application). For example, a MVTV or LFSL may have a digital application stored thereon operable to dynamically adjust one or more LFSLs in one or more dimensions, pitch angles, and/or pitch widths upon receipt of user instruction via manual clicking by a user of an appropriate button on a TV remote or smartphone application. In accordance with various embodiments, a number a view zones may be similarly selected.

In applications where there is one-way communication (e.g. the system only receives user input, such as in solutions where user privacy is a concern), a user may adjust the system (e.g. the distance between the display and a LFSL, etc.) with a remote or smartphone application until they are satisfied with the display of one or more view zones. Such systems may, for instance, provide a high-performance, self-contained, simple MVTV system that minimises complications arising from the sensitivity of view zone quality on minute differences from predicted relative component configurations, alignment, user perception, and the like.

The skilled artisan will appreciate that while a smartphone application or other like system may be used to communicate user preferences or location-related data (e.g. a quality of perceived content from a particular viewing zone), such an application, process, or function may reside in a MVTV system or application, executable by a processing system associated with the MVTV. Furthermore, data related to a view zone location may comprise a user instruction to, for instance, adjust a LFSL, based on, for instance, a user perception of an image quality, and the like.

Alternatively, or additionally, a receiver, such as a smartphone camera and digital application associated therewith, may be used to calibrate a display, in accordance with various embodiments. For instance, a smartphone camera directed towards a display may be operable to receive and/or store signals/content emanating from the LFSL or MVTV. A digital application associated therewith may be operated to characterise a quality of a particular view zone through analysis of received content and adjust the LFSL to improve the quality of content at the camera’s location (e.g. to reduce crosstalk from a neighbouring view zone).

For instance, a calibration may be initially performed wherein a user positions themselves in a desired viewing location and points a receiver at a display generating red and blue content for respective first and second view zones. A digital application associated with the smartphone or remote receiver in the first view zone may estimate a distance from the display by any means known in the art (e.g. a subroutine of a smartphone application associated with an MVTV operable to measure distances using a smartphone sensor). The application may further record, store, and/or analyse (e.g. in mobile RAM) the light emanating from the display to determine whether or not, and/or in which dimensions, angle, etc., to adjust a dynamic light field shaping layer to maximise the amount of red light received in the first view zone while minimising that of blue (i.e. reduce cross talk between view zones).

For example, and in accordance with some embodiments, a semi-automatic LFSL may self-adjust until a digital application associated with a particular view zone receives less than a threshold value of content from a neighbouring view zone (e.g. receives at least 95% red light and less than 5% blue light, in the abovementioned example). The skilled artisan will appreciate that various algorithms and/or subroutines may be employed to this end. For instance, a digital application subroutine may calculate an extent of crosstalk occurring between view zones, or determine in which ways views are blended based on MVD content received, to determine which LFSL parameters may be optimised and actuate an appropriate system response. Furthermore, the skilled artisan will appreciate that various means known in the art for encoding, displaying, and/or identifying distinct content may be applied in such embodiments. For example, a MVTV or display having a LFSL disposed thereon may generate distinct content in respective view zones that may comprise one or more of, but is not limited to, distinct colours, IR signals, patterns, or the like, to determine a view zone quality and initiate compensatory adjustments in a LFSL.

Furthermore, and in accordance with yet further embodiments, a semi-automatic LFSL calibration process may comprise a user moving a receiver within a designated range or region (e.g. a user may move a smartphone from left to right, or forwards/backwards) to acquire MVD content data. Such data acquisition may, for instance, aid in LFSL layer adjustment, or in determining a LFSL configuration that is acceptable for one or more users of the system within an acceptable tolerance (e.g. all users receive 95% of their intended display content) within the geometrical limitations of the LFSL and/or MVTV.

The skilled artisan will appreciate that user instructions to any or all of these ends may be presented to a user on the display or smartphone/remote used in calibration for ease of use (i.e. guide the user in during calibration and/or use). Similarly, if, for instance, physical constraints (e.g. LFSL or MVTV geometries) preclude an acceptable amount of crosstalk between views, an application associated with the MVTV, having performed the appropriate calculations, may guide a user to move to a different location to provide for a better experience.

In yet other embodiments, one or more user locations may be determined automatically by a MVTV or system coupled therewith. For instance, view zone locations may be determined via the use of one or more cameras or other like sensors and/or means known in the art for determining user, head, and/or eye locations, and dynamically adjusting a LFSL in one or more dimensions and/or barrier pitch widths/angles to render content so to be displayed at one or more appropriate locations. Yet other embodiments relate to a self-localisation method and system as described above that maintains user privacy with minimal user input or action required to determine one or more view zone locations and dynamically adjust a LFSL to display appropriate content thereto.

The skilled artisan will appreciate that any of the above-described embodiments may have various elements combined and remain within the scope of the disclosure. For instance, a MVTV system comprising a dynamic light field shaping layer having two independently addressable parallax barriers configured to be moved laterally and perpendicularly relative to a display screen via actuators may further comprise a display operable to introduce buffer pixels to further reduce crosstalk between adjacent views. Additionally, or alternatively, a dynamic light field shaping later may be adjusted based on one or more user-advertised viewing locations as described herein with reference to self-localisation techniques for a MVD system. Furthermore, a dynamic light-field shaping layer may further enable increased resolution or decreased crosstalk between view zones in a system displaying perception-adjusted images for a user with reduced visual acuity.

Yet further applications may utilise a dynamic light field shaping layer subjected to oscillations or vibrations in one or more dimensions in order to, for instance, improve perception of an image generated by a pixelated display. Or, such a system may by employed to increase an effective view zone size so as to accommodate user movement during viewing. For example, a LFSL may be vibrated in a direction perpendicular to a screen so to increase a depth of a view zone in that dimension to improve user experience by allowing movement of a user’s head towards/away from a screen without introducing a high degree of perceived crosstalk.

Various embodiments of a MVD system having an adjustable LFSL may, in addition to providing distinct display content, also provide additional preferred content (e.g. audio, language, text, etc.). To this end, various embodiments further relate to a system that comprises a digital application operable to receive as input one or more user audio preferences, languages, text options, and the like, and output appropriate content to a particular view zone. For instance, headphones associated with respective view zones may receive audio content in different languages. The skilled artisan will appreciate that other means of providing directional audio content (e.g. directional speakers) also fall within the scope of this disclosure.

Furthermore, while the above-described embodiments generally refer to dynamic light field shaping layers printed at high resolution to, for instance, overcome resolution limitations of traditional dynamic barriers comprising a LCD screen with RGB colour-subpixels which render “dark” when activated, monochromatic LCD layers may be employed within the scope of the disclosure. In such embodiments, a LFSL may be laterally dynamically adjusted by activating individual pixels for a 3-fold increase in resolution as compared to RGB LCD screens, while the LFSL may be adjusted in a direction perpendicular to a display screen via actuators as described above. In further embodiments, such a LFSL may be disposed on a bright RGB screen to overcome darkening caused by the LFSL, and may offer a 2-dimensional parallax barrier to provide both horizontal and vertical parallax by individually addressing pixels in two dimensions, or by combining two monochromatic LCD screens with 1-dimensional parallax barriers oriented substantially perpendicularly to each other.

While the present disclosure describes various embodiments for illustrative purposes, such description is not intended to be limited to such embodiments. On the contrary, the applicant’s teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A light field shaping system for interfacing with light emanated from underlying pixels of a digital display to define a plurality of distinct view zones, the system comprising:
a light field shaping layer (LFSL) comprising a series of light field shaping elements and disposable relative to the digital display so to align said series of light field shaping elements with said underlying pixels in accordance with a current light field shaping geometry to thereby define the plurality of distinct view zones in accordance with said current geometry;
an actuator operable to translate said LFSL relative to the digital display to adjust alignment of said light field shaping elements with the underlying pixels in accordance with an adjusted geometry thereby adjusting the plurality of distinct view zones; and
a digital data processor operable to activate said actuator to translate said LFSL to dynamically adjust the plurality of distinct view zones.

2. The light field shaping system of claim 1, wherein said actuator is operable to translate said LFSL in a direction perpendicular to the digital display.

3. The light field shaping system of claim 1, wherein said actuator is operable to translate said LFSL in a direction parallel to the digital display.

4. The light field shaping system of claim 1, wherein said actuator comprises a plurality of respective actuators operable to translate said LFSL in respective directions relative to the digital display.

5. The light field shaping system of claim 1, wherein said LFSL comprises a parallax barrier (PB).

6. (canceled)

7. (canceled)

8. (canceled)

9. The light field shaping system of claim 5, wherein said PB comprises a first PB, wherein the system further comprises a second PB disposed relative to the digital display so to define an effective PB dimension for said LFSL, at least in part, as a function of a relative positioning of said first PB to said second PB, that at least partially dictates formation of the plurality of distinct view zones.

10. The light field shaping system of claim 9, wherein said actuator dynamically adjusts said relative positioning to dynamically adjust said effective PB dimension and thereby adjust formation of the plurality of distinct view zones.

11. The light field shaping system of claim 9, wherein said LFSL comprises said first PB and said second PB.

12. The light field shaping system of claim 1, wherein the system stores distinct LFSL geometries designated to correspondingly define a respective number of distinct view zones, and wherein said digital data processor is operable to activate said actuator, given a selected number of distinct view zones, to translate said LFSL to adjust said current geometry to a corresponding one of said distinct geometries to correspondingly select formation of said selected number of distinct view zones.

13. The light field shaping system of claim 1, wherein said digital processor is further operable to receive as input view zone characterization data related to one or more of the plurality of distinct view zones, and automatically initiate a corresponding translation of said LFSL via said actuator to optimize formation of said one or more of the plurality of distinct view zones.

14. The light field shaping system of claim 13, wherein said input data is representative of at least one of a view zone crosstalk, a view zone overlap, a view zone size, or a view zone boundary.

15. The light field shaping system of claim 13, wherein said input data comprises a location of a viewer relative to a given view zone, and wherein said optimization optimizes formation of said given view zone for the viewer.

16. The light field shaping system of claim 13, wherein said input data is acquired via an optical sensor operated within said one or more view zones to capture light emanated therein by the digital display via said LFSL, and communicated therefrom for processing by said digital processor.

17. The light field shaping system of claim 16, wherein said optical sensor comprises a camera on a mobile communication device operated by a viewer via a corresponding mobile application in communication with said digital processor.

18. (canceled)

19. (canceled)

20. (canceled)

21. (canceled)

22. (canceled)

23. (canceled)

24. The light field shaping system of claim 1, wherein said actuator is operable to translate said LFSL in response to a user adjustment signal received from a remote device.

25. (canceled)

26. (canceled)

27. (canceled)

28. (canceled)

29. A method for dynamically adjusting a plurality of distinct view zones in a multiview display (MVD) system comprising a digital display defined by an array of pixels, and light field shaping layer (LFSL) disposed relative thereto, the method comprising:
accessing current view zone characterization data related to one or more of the plurality of distinct view zones produced according to a current LFSL geometry relative to the array of pixels;
digitally identifying a desirable adjustment in said view zone characterization based on said current view zone characterization data; and
automatically translating the LFSL relative to the array of pixels, via a digital processor and an actuator operatively coupled to the LFSL, so to adjust said current LFSL geometry and thereby correspondingly adjust formation of the plurality of distinct view zones in accordance with said desirable adjustment.

30. The method of claim 29, wherein said desirable adjustment comprises an increased or decreased number of distinctly formed view zones.

31. The method of claim 29, wherein said current view zone characterization data comprises view zone image data indicative of a level of view zone crosstalk, and wherein said desirable adjustment comprises a reduction in view zone crosstalk within at least one of the distinct view zones.

32. The method of claim 29, wherein said current view zone characterization data comprises indication of given view zone boundary relative to a given viewer, and wherein said desirable adjustment comprises a distancing of said view zone boundary relative to said given viewer.

33. The method of claim 32, wherein said distancing is dynamically achieved upon laterally shifting said boundary, adjusting a lateral breadth of said given view zone, or increasing a depth of said given view zone to better accommodate a location of said given viewer.

34. The method of claim 29, wherein said translating comprises at least one of laterally translating the LFSL, or a component thereof, parallel to the digital display, translating the LFSL, or a component thereof, perpendicularly to the digital display, or translating a component of the LFSL to correspondingly adjust an effective light field shaping pitch of the LFSL.

35. The method of claim 29, wherein said current view zone characterization data is representative of at least one of a view zone crosstalk, a view zone overlap, a view zone size, or a view zone boundary.

36. (canceled)

37. (canceled)

38. (canceled)

39. The method of claim 29, further comprising:
emitting, via the MVD, respective MVD zone content in each of the plurality of distinct view zones;
optically acquiring, from within one or more of the plurality of distinct view zones, said current view zone characterization data indicative of a perception of said respective MVD zone content as optically perceived therein; and
iteratively translating said LFSL to automatically improve said perception.

40-48. (canceled)
